(19) United States
(12) Patent Application Publication
(10) Pub. No.: US 2021/0121950 A1
(43) Pub. Date: Apr. 29, 2021

(54) NANOSTRUCTURES AND PROCESS FOR PRODUCTION

(71) Applicant: Oxford University Innovation Limited, Oxford (GB)

(72) Inventors: Assia KASDI, Oxford (GB); Christopher ALLEN, Oxford (GB); Mauro PASTA, Oxford (GB); Andrew WATT, Oxford (GB)

(21) Appl. No.: 17/043,835

(22) PCT Filed: Apr. 5, 2019
(86) PCT No.: PCT/GB2019/051009

§ 371 Date: Sep. 30, 2020

(30) Foreign Application Priority Data
Apr. 5, 2018 (GB) 1805662.2

(51) Int. Cl. B22F 1/00; B22F 1/02; B22F 9/24; C22C 1/04; C22C 9/06

(52) U.S. Cl. CPC B22F 1/0025; B22F 1/02; B22F 9/24; B82Y 30/00; C22C 9/06; C22C 1/0433; C22C 1/0425

(57) ABSTRACT

The invention provides a process for producing a nanostructure comprising a first metal having a first reduction potential and a second metal having a second reduction potential, the second reduction potential being more negative than the first reduction potential. The process involves a catalyst which is a salt of a reducing metal. The nanostructure may be in the form of a nanowire. The process can provide true nanoalloy products and core-shell nanostructures. The invention further provides a nanoalloy comprising a first metal having a first reduction potential and a second metal having a second reduction potential, the second reduction potential being more negative than the first reduction potential. The invention provides a nanoalloy with an oxide coating. Also provided are a hydrogen storage module and a transparent conductor comprising an optionally oxide-coated nanoalloy according to the invention. Further provided are uses of the optionally oxide-coated nanoalloy of the invention in a method of hydrogen storage, in the manufacture of a transparent conductor and as a catalyst.

### FIELD OF THE INVENTION

The present invention provides a process for making nanostructures comprising two or more metals. The invention further provides nanostructures obtainable by the process of the invention. In particular, the invention provides nanoalloys containing two or more metals, oxide-coated nanoalloys, and processes for producing such nanoalloys. The invention further provides a hydrogen storage module or transparent conductor comprising a nanoalloy according to the invention, and also provides the use of nanoalloys according to the invention in methods of hydrogen storage, as a hydrogen storage material, in the manufacture of a transparent conductor and as a catalyst.

### BACKGROUND TO THE INVENTION

Bimetallic nanoparticles are known to be useful in a wide variety of applications due to their enhanced optoelectronic and electrochemical properties. Among these structures, core-shell structures (i.e. structures having a core of a first metal surrounded by a shell of a differing metal composition) and structures containing mixtures of metals are of particular interest as they have been found to have advantageous catalytic, magnetic, optical and corrosion-resistant properties.

Core-shell structures are described in Wang et al: “Multimetallic Au/FePt3 Nanoparticles as Highly Durable Electrocatalyst”, Nano Letters 11, 919-926, (2010); Wei et al: “Improvement of oxygen reduction reaction and methanol tolerance characteristics for PdCo electrocatalysts by Au alloying and CO treatment”, Chemical Communications 47, 11927-11929, (2011) and Alayoglu et al: “Ru—Pt core-shell nanoparticles for preferential oxidation of carbon monoxide in hydrogen”, Nat Mater 7, 333-338 (2008). Mixed-metal nanoparticles are described in Xu et al: “Facile one-step room-temperature synthesis of Pt3Ni nanoparticle networks with improved electro-catalytic properties”, Chemical Communications 48, 2665-2667, (2012); Yoo et al: “Polymer-Incarcerated Gold-Palladium Nanoclusters with Boron on Carbon: A Mild and Efficient Catalyst for the Sequential Aerobic Oxidation—Michael Addition of 1, 3-Dicarbonyl Compounds to Allylic Alcohols”, Journal of the American Chemical Society 133, 3095-3103 (2011); and Gu et al: “Synergistic Catalysis of Metal-Organic Framework-Immobilized Au—Pd Nanoparticles in Dehydrogenation of Formic Acid for Chemical Hydrogen Storage”, Journal of the American Chemical Society 133, 11822-11825 (2011).

Metallic nanowires are a class of nanoparticle that has great potential in the field of electrochemistry. Their shape confers upon them a high surface to volume ratio that has been exploited in optoelectronics. Bimetallic nanowires have particular potential for improved optical and catalytic properties. True metal nanoalloys, for instance in the form of nanowires, are particularly sought after because they may provide enhanced site-specific activity. Moreover, true nanoalloys may be more stable and have more precisely tunable properties than bimetallic nanostructures having regions of differing composition.

One area where the special properties of nanostructures and particular nanowires may find suitable application is in hydrogen storage and the Hydrogen Evolution Reaction (HER). Currently, platinum is the most efficient electrocatalyst for the HER, owing to a fast hydrogen bond release at low overpotential for this reaction. Unfortunately, the cost and scarcity of the metal prohibits its large-scale application as an electrocatalyst. Therefore, alternative cheaper materials capable of competing with Pt are highly desirable and much work has been done to seek cheaper materials which have can perform as efficient electrocatalysts for the hydrogen evolution reaction (see, for instance, Jakšić: “Hypo-hyper-d-electronic interactive nature of synergism in catalysis and electrocatalysis for hydrogen reactions”, Electrochimica Acta 45, 4085-4099 (2000) or Greeley et al: “Computational high-throughput screening of electrocatalytic materials for hydrogen evolution”, Nature materials 5, 909 (2006).

However, the methods for producing nanostructures available thus far suffer from considerable difficulties. For instance, methods of generating bimetallic nanostructures are typically slow, requiring heating often for periods upwards of ten hours, sometimes for more than fifty hours, to produce the desired products. Moreover, existing methods cannot easily be tuned to produce nanostructures of a desired shape or of a desired metallic composition.

Furthermore, attempts to make true metal alloy nanoparticles (nanoalloys) have met with limited success. This is due to unfavourably competing precursor reactivities, leading to the formation of phase segregated nanomaterials such as core-shell nanoparticles. In consequence, despite their potential, nanostructures and particularly nanowires comprising alloys have rarely been reported in the literature, and the materials disclosed mostly involve the presence of at least one noble metal. See, for instance, Chen et al: “Ultralong PtNi alloy nanowires enabled by the coordination effect with superior ORR durability”, RSC Adv., 6, 71501-71506 (2016). This publication describes a method of forming a platinum nanowire and subsequently diffusing nickel into the platinum nanowire to form a nanostructure comprising both platinum and nickel. However, true metal alloy nanowires have not previously been reported.

Moreover, the nanostructures which have been reported often suffer from considerable disadvantages which make them unsuitable for hydrogen evolution reactions. For instance, bimetallic nickel-based materials have been reported (Hong, X. et al: “Ultrathin Au—Ag bimetallic nanowires with Coulomb blockade effects”, Chemical Communications 47, 5160-5162, (2011); McKone et al: “Ni—Mo Nanopowders for Efficient Electrochemical Hydrogen Evolution”, ACS Catalysis 3, 166-169, (2013)) and are said to possess activities similar to platinum. However, these materials are susceptible to corrosion in acidic media and are consequently unsuitable for contact with hydrogen ions in solution.

In consequence, there remains a need to provide a lower-energy, faster synthesis of bimetallic nanostructures. In particular, there remains a need for a process which can provide true nanoalloys, particularly in the form of nanowires.

### SUMMARY OF THE INVENTION

The present inventors have surprisingly found that a catalysed co-reduction method can be used to overcome the problems associated with the prior art and to produce true alloys.

The co-reduction approach described herein involves treating a reductant, which is a fatty species comprising a polar moiety, with a salt of a first metal, a salt of a second metal, and a catalyst which is a salt of a reducing metal. The catalyst is a salt of a reducing metal. It is surprisingly found that, in the reduction process, the reducing metal facilitates the transfer of electrons from the reductant to the first and second metal, allowing the formation of nanostructures comprising the first and second metals to occur more easily than in the absence of the catalyst. The reducing metal has a more negative reduction potential than the first and second metals (that is, it is less likely to gain electrons than the first or second metals). It has unexpectedly been found that the presence of a salt of such a reducing metal accelerates the process, perhaps by mediating the electron transfer from the fatty species (reductant) to the first and second metals. As a result, the inventors have been able to synthesise nanostructures and particularly nanowires more quickly and efficiently than by following previous methods. This advantageous effect is not suggested anywhere in the above mentioned prior art, and was therefore unexpected.

The invention therefore provides a process for producing a nanostructure wherein the nanostructure comprises:
a first metal having a first reduction potential; and
a second metal having a second reduction potential, the second reduction potential
being more negative than the first reduction potential, wherein the process comprises treating a fatty species comprising a polar moiety capable of
coordinating to a metal ion with:
a salt of the first metal;
a salt of the second metal; and
a catalyst,
   the catalyst being a salt of a reducing metal, the reducing metal having a reduction potential that is more negative than both the first and the second reduction potentials.

A nanostructure obtainable by the process of the invention is also provided. The nanostructure may be a core-shell structure.

Alternatively, the nanostructure may be a nanoalloy. Indeed, it has further been surprisingly found that, when the catalyst comprises a small counterspecies such as a halide anion, the method can produce true nanoalloys. Co-reducing two metals usually does not lead to true nanoalloys because the reductant tends to reduce the more oxidising metal first and the less oxidising metal second, which favours the formation of core-shell structures. However, the present inventors have found that the method of the invention, involving a catalyst comprising a small counterspecies such as a halide, can lead to a true nanoalloy. Without wishing to be bound by theory, it is speculated that the reducing metal and small counterspecies might form a complex capable of simultaneously reducing the first metal and the second metal. True simultaneous reduction avoids the favouring of a structure comprising an inner core of the more oxidising metal with an outer shell of the less oxidising metal, formed as the more oxidising metal is depleted in the reaction mixture.

The invention therefore provides a nanoalloy obtainable by the process of the invention. In particular, the invention provides a nanoalloy in the form of a nanowire obtainable by the process of the invention.

Also provided is a nanoalloy comprising:
a first metal having a first reduction potential; and
a second metal having a second reduction potential, the second reduction potential being more negative than the first reduction potential.

The nanoalloys of the invention typically have a low overpotential with respect to the hydrogen evolution reaction. The invention therefore also provides a hydrogen storage module comprising a nanoalloy according to the invention, the use of such a nanoalloy in a method of hydrogen storage and the use of such a nanoalloy as a hydrogen storage material.

The nanoalloys of the invention may also have optical properties which are suited to their use as transparent conductors. The invention therefore provides a transparent conductor comprising a nanoalloy according to the invention, and the use of such a nanoalloy in the manufacture of a transparent conductor. The use of such a nanoalloy as a transparent conductor is also provided.

The nanoalloys of the invention have highly tunable electrical properties and may also have site-specific catalytic activity. The invention therefore also provides the use of a nanoalloy according to the invention as a catalyst.

### BRIEF DESCRIPTION OF THE FIGURES

FIG. 1 illustrates the synthesis method of growth of copper nanowires using oleylamine as a fatty species or reductant.

FIG. 2 (a) shows a TEM micrograph of a single copper-nickel core shell micrograph; (b) is a detail of the micrograph of 2(a), also including FFT images of the portions of that micrograph identified as regions a, b, and c in FIG. 2(a); (c) is an SEM image of nanowires produced by the methods herein; FIG. 2(d) is an STEM image of each of Cu, Ni and copper-nickel nanowires; Figures (e) and (f) are line scans respectively collinear with and perpendicular to the axis of the nanowire in each case.

FIG. 3(a) is a TEM image of a single copper-nickel nanoalloy nanowire. FIG. 3(b) is an EDX map of Cu, Ni and both Cu and Ni throughout the nanowire. FIG. 3(c) is a detail of the image displayed in (a). FIGS. 3(d) and (e) are line scans taken in a direction collinear with and horizontal to the nanowire axis.

FIG. 4(a) shows a copper-nickel nanoalloy at the nanowire edge, FIG. 4(b) is a detail of the extreme edge, 4(c) is an FFT image of the oxide part of the nanowire and FIG. 4(d) is an FFT image of the non-oxide part of the nanowire shown in 4(c).

FIG. 5 shows simulated core-shell and alloy nanowire XRD plots in comparison to the XRD plots of the bimetallic nanowires synthesised herein.

FIG. 6 shows the effect of the concentration of the catalyst on the morphology of the nanowires produced. In particular, FIG. 6(a) shows the effect on the Ni/Cu atomic percentage ratio in the nanowire and FIG. 6(b) shows the effect on the aspect ratio.

FIG. 7(a) shows polarization curves of copper nanowires, copper-nickel nanoalloys having a 1:1 atomic ratio, copper-nickel nanoalloys having a 2:1 atomic ratio, core-shell copper-nickel nanostructures and nickel nanowires, as electrocatalysts in 0.5 M H₂SO₄ solution. FIG. 7(b) shows Tafel plots obtained from the polarization curves in FIG. 7(a).

FIG. 8 is a schematic illustration of the effect of the precursor compounds used in the process of the invention on the final composition and atomic arrangement of the product.

### DETAILED DESCRIPTION OF THE INVENTION

As defined above, the invention provides in one aspect a process for producing a nanostructure wherein the nanostructure comprises:
a first metal having a first reduction potential; and
a second metal having a second reduction potential, the second reduction potential
being more negative than the first reduction potential,
wherein the process comprises treating a fatty species comprising a polar moiety capable of coordinating to a metal ion with:
   a salt of the first metal;
   a salt of the second metal; and
   a catalyst,
      the catalyst being a salt of a reducing metal, the reducing metal having a reduction potential that is more negative than both the first and the second reduction potentials.

In another aspect, the invention provides a nanoalloy comprising:
a first metal having a first reduction potential; and
a second metal having a second reduction potential, the second reduction potential being more negative than the first reduction potential.

The various features of both the above-defined aspects of the invention will now be defined and discussed in more detail below. It should be understood that, as the process of the invention can be used to provide the nanoalloy of the invention, the following discussion of aspects of the process of the invention relates also to the products of the invention and vice versa.

### Fatty Species (Reductant)

The process of the invention involves treating a fatty species with salts of a first metal, second metal, and a reducing metal. The fatty species comprises a polar moiety capable of coordinating to a metal ion. The fatty species also comprises a fatty backbone attached to the polar moiety.

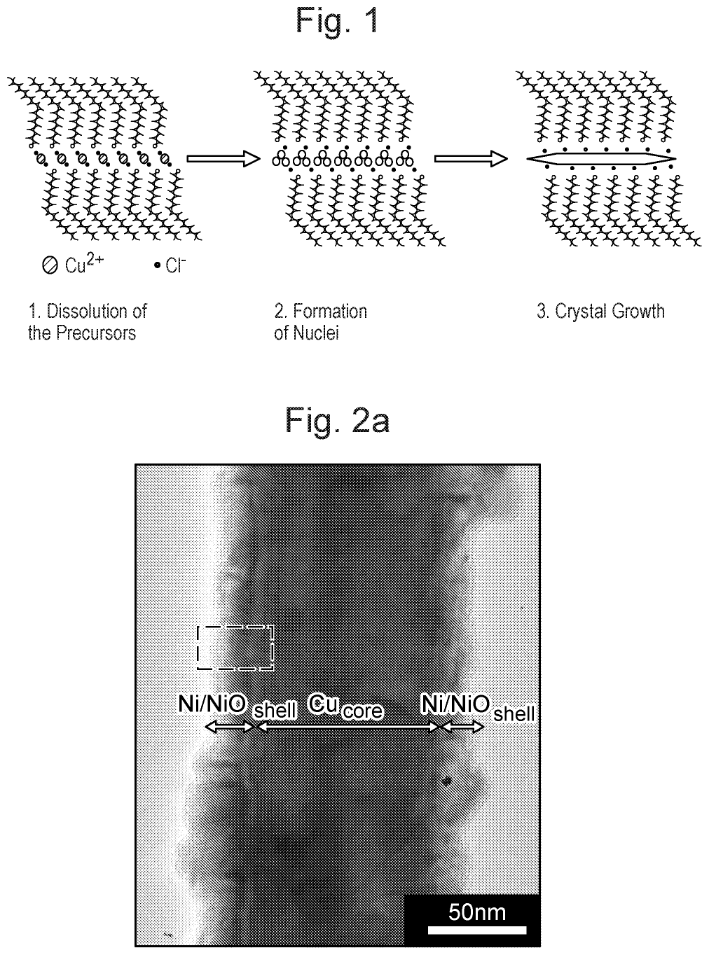

During the reaction, the fatty species acts as a reductant. Thus, during the reaction, the salt of the first metal and the salt of the second metal are reduced by the fatty species to form metals. However, the fatty species is not simply a reductant. During reaction, so-called metallic “seeds” are formed, comprising the first metal and/or the second metal. The polar moiety of the fatty species co-ordinates to these seeds and stabilises the nanostructures as they grow from these seeds. The shape of the fatty backbone can therefore influence the shape of the nanostructure grown during the reaction. To favour nanowires, fatty species comprising hydrocarbon chains as a fatty backbone are preferred. The synthesis method is illustrated in FIG. 1. In step 1, the precursors (the fatty species and metal ion or ions to be reduced) are dissolved. In step 2, nuclei of reduced metal form, coordinated to the nitrogen head groups of the oleylamine fatty amine species within a hydrocarbon shell formed by the hydrogen tails of the fatty amines. In step 3, the nanowires grow within the shell.

The polar moiety is usually electronegative. The polar moiety usually acts as an electron donor, or is capable of donating electrons. Typically, the polar moiety comprises one or more heteroatoms selected from O, N, and S. The polar moiety is typically uncharged. In some aspects, the polar moiety may for instance carry a negative charge or a positive charge, preferably a negative charge. Examples of suitable polar moieties include —NH₂, —NHR′, —NR′₂, —SH, —SR′, —PO₃H, —PO₃⁻, —PO₂R′, —COOH, —COO⁻ and —COOR′ wherein R′ is selected from C₁-C₆ alkyl, C₂-C₆ alkenyl, C₂-C₆ alkynyl and a group R as discussed below. The hyphen indicates the attachment of the polar moiety to the fatty backbone.

In a preferred embodiment, the polar moiety of the fatty species is selected from a thiol group, a phosphate group, a carboxylic acid group and an amine group. Preferably, the polar moiety is an amine group selected from —NH₂, —NHR′, and —NR′₂, preferably —NH₂.

The fatty backbone typically consists of one or more optionally substituted hydrocarbon chains. In some embodiments, the fatty backbone may comprise a cyclic optionally substituted hydrocarbon species. Generally, the fatty species comprises a saturated or unsaturated carbon chain comprising at least 8 carbon atoms.

The fatty backbone usually comprises one or more —R groups (the hyphen indicating the point of attachment to the polar moiety) wherein —R is selected from C₁-C₃₀ alkyl, C₂-C₃₀ alkenyl, C₂-C₃₀ alkynyl, C₃-C₃₀ cycloalkyl, C₄-C₃₀ cycloalkenyl and C₆-C₃₀ cycloalkynyl optionally substituted with one or more substituents selected from halide, hydroxy, C₁-C₃₀ alkyl, C₂-C₃₀ alkenyl, C₂-C₃₀ alkynyl, C₃-C₃₀ cycloalkyl, C₄-C₃₀ cycloalkenyl and C₆-C₃₀ cycloalkynyl, C₆-C₁₀ aryl, and C₆-C₁₀ heteroaryl comprising one or more heteroatoms selected from O, N and S.

Preferably —R is selected from C₂-C₃₀ alkyl, C₂-C₃₀ alkenyl, and C₂-C₃₀ alkynyl, optionally substituted with one, two, three, four, five, six, seven, eight, nine or ten substituents independently selected from halide, hydroxy, C₁-C₁₀ alkyl, C₂-C₁₀ alkenyl, C₂-C₁₀ alkynyl.

More preferably, —R is selected from C₈-C₂₂ alkyl, C₈-C₂₂ alkenyl, and C₈-C₂₂ alkynyl, optionally substituted with one, two, or three substituents independently selected from halide, hydroxy, C₁-C₆ alkyl and C₂-C₆ alkenyl. For example, —R may be unsubstituted.

Where the fatty backbone comprises more than one —R group, the fatty backbone typically comprises one —R group selected from C₈-C₂₂ alkyl, C₈-C₂₂ alkenyl, and C₈-C₂₂ alkynyl, optionally substituted with one, two, or three substituents independently selected from halide, hydroxy, C₁-C₆ alkyl and C₂-C₆ alkenyl and any remaining —R groups are selected from C₁-C₃₀ alkyl, C₂-C₃₀ alkenyl, C₂-C₃₀ alkynyl, C₃-C₃₀ cycloalkyl, C₄-C₃₀ cycloalkenyl and C₆-C₃₀ cycloalkynyl optionally substituted with one or more substituents selected from halide, hydroxy, C₁-C₃₀ alkyl, C₂-C₃₀ alkenyl, C₂-C₃₀ alkynyl, C₃-C₃₀ cycloalkyl, C₄-C₃₀ cycloalkenyl and C₆-C₃₀ cycloalkynyl, C₆-C₁₀ aryl, and C₆-C₁₀ heteroaryl comprising one or more heteroatoms selected from O, N and S. In a particular embodiment, where the fatty backbone comprises more than one —R group, all —R groups are selected from C₈-C₂₂ alkyl, C₈-C₂₂ alkenyl, and C₈-C₂₂ alkynyl, optionally substituted with one, two, or three substituents independently selected from halide, hydroxy, C₁-C₆ alkyl and C₂-C₆ alkenyl. For instance, all said —R groups may be unsubstituted.

Examples of fatty species include RNH₂, RNHR′, RNR′₂, RSH, RSR′, RPO₃H, RPO₃⁻, RPO₂R′, RCOOH, RCOO⁻ and RCOOR′ wherein R and R′ are as defined above.

In one aspect, the fatty species is a fatty amine. The fatty amine may be selected from a primary amine, a secondary amine or a tertiary amine. For instance, the fatty species may be NR₃, NR₂R′, NRR′₂, NHR₂, NHRR′, or NH₂R, where R and R′ are as defined above.

Preferably, the fatty species is a primary amine. A primary amine may be favoured due to its ease of coordination to metal ions. For instance, the fatty species may be NH₂R, wherein R is as defined above. Particularly preferably, the fatty species is a primary amine NH₂R, wherein R is selected from C₈-C₂₂ alkyl, C₈-C₂₂ alkenyl, and C₈-C₂₂ alkynyl, optionally substituted with one, two, or three substituents independently selected from halide, hydroxy, C₁-C₆ alkyl and C₂-C₆ alkenyl. R may for instance be selected from C₈-C₂₂ alkyl and C₈-C₂₂ alkenyl, which may be substituted as previously defined. usually, however, R is unsubstituted.

In a particularly preferred embodiment, the fatty amine is oleylamine.

### First, Second and Third Metals

The process of the invention comprises treating the fatty species with a salt of the first metal and a salt of a second metal. The first metal has a first reduction potential and the second metal has a second reduction potential. In some embodiments, the process further comprises treating the fatty species additionally with a salt of a third metal, the third metal having a third reduction potential. Preferably, though, the process comprises treating the fatty species with a salt of the first metal and a salt of the second metal but not with a salt of a third metal. This leads to a bimetallic nanostructure.

It should be noted that by “reduction potential” of a metal is meant the standard reduction potential (that is, the reduction potential as measured by the standard hydrogen electrode) for the reaction:

Mⁿ⁺(aq)+n e⁻→M(s)

where Mⁿ⁺ indicates the metal ion in its typical valence state in aqueous solution, while M(s) indicates the solid metal. Frequently, n=1 or 2. For instance, the standard reduction potential of sodium is the standard reduction potential for the reaction:

Na⁺(aq)+e⁻→Na(s)

because sodium forms singly-charged cations in aqueous solution. By contrast, the standard reduction potential of zinc is the standard reduction potential for the reaction:

Zn²⁺(aq)+2e⁻→Zn(s)

because zinc forms divalent cations in aqueous solution.

The more negative the reduction potential, the less thermodynamically favourable it is for the metal ion in solution to regain electrons and form solid metal.

Typical standard reduction potentials (E⁰) are shown in Table 1.

TABLE 1
Standard reduction potentials of various metals

| Reduction reaction | E⁰/V |
|---|---|
| Pt²⁺ + 2 e⁻ | 1.118 |
| Ag⁺ + e⁻ | 0.7996 |
| Cu²⁺ + 2 e⁻ | 0.34 |
| Pb²⁺ + 2 e⁻ | −0.126 |
| Ni²⁺ + 2 e⁻ | −0.25 |
| Zn²⁺ + 2 e⁻ | −0.76 |

The reduction potential of the first metal relative to the reduction potential of the second metal and where present the reduction potential of the third metal is not particularly important. These potentials differ from one another as the metals themselves are different. However, an advantage of the process of the invention is that the catalyst enables metals of differing reduction potential to be reduced simultaneously. In some embodiments, therefore, the reduction potential of the first metal differs from the reduction potential of the second metal by at least 0.01 V, for instance at least 0.05 V or at least 0.1 V. The reduction potential of the third metal may differ from the reduction potential of the second metal by at least 0.01 V, for instance at least 0.05 V or at least 0.1 V.

The salt of the first metal, the second metal and where present the third metal are typically stable in standard polar or non-polar solvents. That is, the salts of the first metal, second metal and where present of the third metal do not usually oxidise or reduce the solvent during the reaction. Accordingly, the first, second and where present the third metal usually have reduction potentials which are insufficiently positive or negative to oxidise or reduce a solvent such as a hydrocarbon solvent.

In some embodiments, therefore, the first reduction potential and/or the second reduction potential are more negative than 1 V. Similarly, the third reduction potential is usually more negative than 1 V. The first reduction potential and/or the second reduction potential are usually more positive than −0.3 V. Similarly, the third reduction potential is usually more positive than −0.3 V. Thus, in one embodiment, the first reduction potential and the second reduction potential are more negative than 1 V and more positive than −0.3 V. In an aspect of this embodiment, the third reduction potential is less than 1 V and more positive than −0.3 V. In a particularly preferred embodiment, the first second and third reduction potentials are all from −0.3 V to 1V.

Generally, the first metal and/or the second metal is a transition metal. Where present the third metal is usually a transition metal. In a preferred embodiment, the first metal, the second metal and (where present) the third metal are transition metals.

The term “transition metal” as used herein means any one of the three series of elements arising from the filling of the 3d, 4d and 5d shells, and situated in the periodic table following the alkaline earth metals. This definition is used in N. N. Greenwood and A. Earnshaw “Chemistry of the Elements”, First Edition 1984, Pergamon Press Ltd., at page 1060, first paragraph, with respect to the term “transition element”. The same definition is used herein for the term “transition metal”. Thus, the term “transition metal”, as used herein, includes all of Sc, Y, Ti, Zr, Hf, V, Nb, Ta, Cr, Mo, W, Mn, Tc, Re, Fe, Ru, Os, Co, Rh, Jr, Ni, Pd, Pt, Cu, Ag, Au, Zn, Cd and Hg. These are also referred to as the first, second and third row transition metals (i.e. the transition metals in periods 4, 5 and 6 of the periodic table).

Transition metals are particularly favoured as they are useful in providing nanostructures such as nanoalloys with useful electronic, optoelectronic, magnetic and catalytic properties. However, in other embodiments it is contemplated that one or more of the first, second and where present third metals may be for instance a rare earth metal; a lanthanide metal or an actinide metal. The terms “lanthanide” and “rare earth element”, as used herein, take their normal meaning in the art. Thus, “rare earth element” refers to an element falling within Group II of the Periodic Table while “lanthanide” means any one of the fifteen metallic chemical elements with atomic numbers 57 through 71, from lanthanum through lutetium, i.e. any one of La, Ce, Pr, Nd, Pm, Sm, Eu, Gd, Tb, Dy, Ho, Er, Tm, Yb and Lu.

Other metals contemplated as candidates for the first metal, the second metal and (where present) the third metal include indium, thallium and lead.

An advantage of the present invention is that nanostructures can be produced without the use of noble metals. The process of the invention allows nanostructures such as nanoalloys, particularly in the form of nanowires, to be produced having similar catalytic and electronic properties to such noble metals, without requiring the presence of a noble metal itself. The process of the invention can therefore be used to produce advantageous nanomaterials more cheaply than by a method requiring the use of one or more noble metals.

In a preferred aspect, one or more of the first, second and (where present) third metals is a non-noble transition metal. For instance, one or more of the first, second and (where present) third metals may be selected from the transition metals excluding platinum, palladium, gold and silver. In a further example of this embodiment, one or more of the first, second and (where present) third metals may be selected from the transition metals excluding platinum, palladium, gold, silver, ruthenium, osmium, rhodium and iridium.

In a further aspect of this embodiment, the first, second and (where present) third metals may all be selected from the transition metals excluding platinum, palladium, gold and silver. In a further example of this embodiment, each of the first, second and (where present) third metals may be selected from the transition metals excluding platinum, palladium, gold, silver, ruthenium, osmium, rhodium and iridium.

For instance, the process of the invention may be a process for producing a nanostructure which does not comprise any of the metals platinum, palladium, gold, and silver. The process may further be a process for producing a nanostructure which does not comprise any of the metals platinum, palladium, gold, silver, ruthenium, osmium, rhodium and iridium.

In one aspect, the first metal is copper. For instance, the salt of the first metal may be copper halide, e.g. copper chloride.

In one aspect, the second metal and (where present) the third metal is selected from iron, tin, cobalt, manganese or nickel, preferably nickel. For instance, the salt of the second metal (and where present the third metal) may be selected from a halide, hydroxide, ammonium, acetylacetonate, acetate or carboxylate salt of iron, tin, cobalt, manganese or nickel.

### Reducing Metal

The process of the invention comprises treating a fatty species with a catalyst which is a salt of a reducing metal. The reducing metal has a reduction potential which is more negative than the reduction potential of the first metal, the second metal and (where present) the third metal. Thus, the reducing metal is capable of reducing ions of the first metal to the metallic state of the first metal, and is capable of reducing ions of the second metal to the metallic state of the second metal.

The reducing metal generally has a negative reduction potential. Where the reduction potential of the reducing metal is negative, the reducing metal is capable of reducing other metals which have a positive reduction potential, such as copper. The more negative the reduction potential of the reducing metal, the more metals it is capable of reducing. Thus, the more negative the reduction potential of the reducing metal, the wider the range of first, second and third metals may be used to form the nanostructure. For instance, where the reducing metal has a reduction potential of −0.1 V, the reducing metal cannot easily reduce Ni²⁺ to nickel (standard reduction potential of −0.25 V). Thus, a reducing metal with a reduction potential of −0.1 V cannot easily produce nanostructures comprising nickel. However, where the reducing metal has a reduction potential such as −0.76 V (as in the case of zinc), the reducing metal is capable of reducing Ni²⁺ and the process can therefore easily be used to produce nanostructures comprising nickel.

Thus, typically the reduction potential of the reducing metal is more negative than −0.3 V. For instance, the reduction potential of the reducing metal may be more negative than −0.5 V.

However, metals having a reduction potential which is excessively negative are less useful in the process of the invention as they are less capable of mediating electron transfer from the reductant to the salt of the first metal, the salt of the second metal and, where present, to the salt of the third metal. Thus, usually the reduction potential of the reducing metal is less negative than −2.9 V. For instance, the reduction potential of the reducing metal may be less negative than −2 V.

In an aspect of the invention, the reduction potential of the reducing metal is from −2.9 V to −0.3 V. For instance, the reduction potential of the reducing metal may be from −0.3 V to −2 V, or for instance from −0.6 V to −1.5 V, for example from −0.7 V to −1.2 V, or −0.70 V to −1.0 V, or from −0.75 to −0.85 V.

Preferably the reducing metal is a transition metal, where the transition metal is as defined above. Transition metals are particularly preferred for their catalytic activities, which it is thought makes them more capable than main group metals, and particularly more capable than s-block metals, of facilitating electron transfer from the reductant to the salt of the first meta, the salt of the second metal and, where present, to the salt of the first metal. However, other candidates for the reducing metal such as thallium and lead are also contemplated in the invention.

The reducing metal is typically a d-block metal. By d-block metal is meant a metal in any one of groups 3 to 12 of the periodic table. The d-block includes all of Sc, Ti, V, Cr, Mn, Fe, Co, Ni, Cu, Zn, Y, Zr, Nb, Mo, Tc, Ru, Rh, Pd, Ag, or Cd.

For instance, it may be preferred that the reducing metal is a transition metal having a reduction potential of from −2.9 V to −0.3 V or, for instance, of from −0.3 V to −2.0 V. The transition metal may for instance have a reduction potential of from −0.6 V to −1.5 V, for example from −0.7 V to −1.2 V, or −0.70 V to −1.0 V, or from −0.75 to −0.85 V. In a preferred embodiment, the reducing metal is a transition metal having a reduction potential of from −0.6 to −1.5 V.

Exemplary reducing metals are chromium, cobalt, iron, zinc, manganese, cadmium or vanadium, preferably zinc.

The salt of the reducing metal may preferably be a halide salt or an acetylacetate salt. The salt of the reducing metal may therefore be a halide salt or an acetylacetate salt of a transition metal having a reduction potential of from −0.6 to −1.5 V, and is preferably a halide salt or an acetylacetate salt of zinc.

### Trimetallic Process

Where the process of the invention comprises treating a fatty species only with a first metal salt, a second metal salt and a catalyst, the nanostructure thus produced is typically a bimetallic structure. Generally, little of the reducing metal is found in the nanostructure product.

The process of the invention is advantageous in that it is not limited to the production of bimetallic nanostructures. The catalyst may catalyse the reduction of not only a first metal salt and a second metal salt to the first and second metal respectively; it may also catalyse the reduction of a third metal salt to a third metal.

Thus, in a further embodiment the process of the invention provides a nanostructure comprising:

a first metal having a first reduction potential;
a second metal having a second reduction potential, the second reduction potential being more negative than the first reduction potential, and
a third metal having a third reduction potential, the third reduction potential being more negative than the second reduction potential;
wherein the process comprises providing a mixture of:
a salt of the first metal;
a salt of the second metal;
a salt of the third metal;
a catalyst; and
a fatty species comprising a polar moiety capable of coordinating to a metal ion, the catalyst being a salt of a reducing metal, the reducing metal having a reduction potential that is more negative than each of the first, second and third reduction potentials.

Typically the nanostructure product comprises less than 5% by weight of the reducing metal, for example less than 1% by weight of the reducing metal. However, the reducing metal may nonetheless be present in a small amount. The inclusion of such a small quantity of reducing metal or indeed other metallic contaminants is not considered when labelling the nanostructure a bimetallic or trimetallic species.

### Metal Salt Species

Usually, the salts of each of the first, second and (where present) the third metal comprise a metal ion. This is most usually a cation of the metal, such as an M⁺, M²⁺ or M³⁺ ion where M indicates the first, second or third metal. However, it is envisaged that the metal ion may alternatively be present in the form of a complex ion carrying a negative charge, such as an MO⁻, MO₂⁻, MO₃⁻, or MO₄⁻, ion, where M indicates the first, second or third metal. Another alternative envisaged within the invention is that the metal in the salt of the first, second and (where present) third metal may nominally carry no charge. Most usually, though, the salt of the first, second and (where present) third metal each comprises a positively-charged metal ion. Typically, the salt of the first, second and (where present) third metal each comprises a monatomic positively-charged metal ion.

Also usually, the salts of each of the first, second and (where present) third metal comprise a ligand. A ligand comprised in a salt of the first metal is referred to as a first ligand; a ligand comprised in a salt of the second metal is referred to as a second ligand; and a ligand comprised in a salt of the third metal is referred to as a third ligand.

The said first ligand, second ligand and (where present) third ligand are each independently charged or uncharged.

Usually, the corresponding metal species is in the form of a positively-charged metal ion. Where the salt of the first metal comprises a positively-charged ion of the first metal, that salt usually further comprises a negatively-charged first ligand. Where the salt of the second metal comprises a positively-charged ion of the second metal, that salt usually further comprises a negatively-charged second ligand. Where the salt of the third metal is present and comprises a positively-charged ion of the third metal, that salt usually further comprises a negatively-charged third ligand. Suitable negatively-charged ligands include hydroxide, oxide, halide, nitrate, nitrite, sulphide, sulphate, sulphite, thiosulphate, thiocyanate, isothiocyanate, azide, phosphate, phosphite, carbonate, hydrogencarbonate, oxalate, cyanate, cyanide, hypochlorite, chlorite, chlorate, perchlorate, chromate, dichromate, permanganate, deprotonated C₁-C₁₆ alcohol, deprotonated C₂-C₁₆ diol, deprotonated C₁-C₁₆ thiol, deprotonated C₂-C₂₄ dithiol, C₁-C₁₆ carboxylate (preferably acetate), C₂-C₂₄ dicarboxylate, or deprotonated C₃-C₂₄ diketone (preferably acetylacetonate).

However, the first, second or third ligand respectively may carry no charge. Suitable uncharged ligands include C₁-C₁₆ alcohol, C₁-C₂₄ diol, C₁-C₁₆ thiol, C₁-C₂₄ dithiol, C₁-C₁₆ carboxylic acid, C₂-C₂₄ dicarboxylic acid, C₂-C₁₆ ketone, C₃-C₂₄ diketone, CO, C₂-C₁₆ nitrile, C₁-C₁₆ amine, C₁-C₂₄ diamine or ammonia.

Where the salt of the first, second or third metal comprises a metal ion in the form of a complex ion carrying a negative charge, the corresponding first, second or third ligand respectively is usually positively charged. Suitable positively-charged ligands include NH₄⁺, Na⁺ and K⁺.

In a preferred embodiment of the process of the invention:
the salt of the first metal comprises a first ligand;
the salt of the second metal comprises a second ligand; and
where present, the salt of the third metal comprises a third ligand;
   wherein the said first, second and third ligands are each independently negatively charged or uncharged. Preferably, the first, second and (where present) third ligands are each negatively charged.

In a typical aspect of this embodiment of the process of the invention:
the salt of the first metal comprises a monatomic positively charged ion of the first metal and a negatively charged first ligand;
the salt of the second metal comprises monatomic positively charged cation of the second metal and a negatively charged second ligand; and
   where present, the salt of the third metal comprises a monatomic positively charged ion of the first metal and a negatively charged third ligand.

Generally, the first ligand, the second ligand and (where present) the third ligand are each independently selected from hydroxide, oxide, halide, nitrate, nitrite, sulphide, sulphate, sulphite, thiosulphate, thiocyanate, isothiocyanate, azide, phosphate, phosphite, carbonate, hydrogencarbonate, oxalate, cyanate, cyanide, hypochlorite, chlorite, chlorate, perchlorate, chromate, dichromate, permanganate, C₁-C₁₆ alcohol, deprotonated C₁-C₁₆ alcohol, C₁-C₂₄ diol, deprotonated C₁-C₂₄ diol, C₁-C₁₆ thiol, deprotonated C₁-C₁₆ thiol, C₁-C₂₄ dithiol, deprotonated C₁-C₂₄ dithiol, C₁-C₁₆ carboxylic acid, C₁-C₁₆ carboxylate (preferably acetate), C₂-C₂₄ dicarboxylic acid, C₂-C₂₄ dicarboxylate, C₂-C₁₆ ketone, C₃-C₂₄ diketone, deprotonated C₃-C₂₄ diketone (preferably acetylacetonate), CO, C₂-C₁₆ nitrile, C₁-C₁₆ amine, C₁-C₂₄ diamine or ammonia.

Preferably, the first ligand, the second ligand and (where present) the third ligand are each independently selected from halide (by which is meant fluoride, chloride, bromide or iodide), hydroxide, nitrate, nitrite, sulphate, sulphite, thiosulphate, thiocyanate, isothiocyanate, carbonate, hydrogencarbonate, oxalate, cyanate, cyanide, C₁-C₆ carboxylate (preferably acetate) and acetylacetate.

In a preferred embodiment, at least one of the first ligand and the second ligand is halide, preferably chloride. In a further preferred embodiment, at least one of the first ligand and the second ligand is acetate or acetylacetonate. These particular ligands are readily available and easy to handle.

Thus, in a preferred embodiment the first metal salt, the second metal salt and (where present) the third metal salt are selected from halide, hydroxide, nitrate, nitrite, sulphate, sulphite, thiosulphate, thiocyanate, isothiocyanate, carbonate, hydrogencarbonate, oxalate, cyanate, cyanide, C₁-C₆ carboxylate (preferably acetate) and acetylacetate salts of transition metals wherein the said transition metals have reduction potentials of from −0.3 V to 1 V. In a particularly preferred embodiment, the first metal salt and the second metal salt are selected from halide and acetylacetate salts of copper and nickel.

As regards the reducing metal, the salt of the reducing metal may preferably be a halide, hydroxide, nitrate, nitrite, sulphate, sulphite, thiosulphate, thiocyanate, isothiocyanate, carbonate, hydrogencarbonate, oxalate, cyanate, cyanide, C₁-C₆ carboxylate (preferably acetate) and acetylacetate of a transition metal having a reduction potential of from −0.6 to −1.5 V. Particularly preferably the salt of the reducing metal may be a halide or acetylacetate salt of a transition metal having a reduction potential of from −0.6 to −1.5 V and is preferably a halide salt or an acetylacetate salt of zinc.

In a particularly preferred embodiment, therefore, the invention provides a process for producing a nanostructure (preferably a nanoalloy in the form of a nanowire) wherein the nanostructure comprises:
a first metal which is a transition metal having a first reduction potential of from −0.3 V to 1 V; and
a second metal which is a transition metal having a second reduction potential of from −0.3 V to 1 V, the second reduction potential being more negative than the first reduction potential,
   wherein the process comprises treating a fatty species which is selected from C₈-C₂₂ alkylamine and C₈-C₂₂ alkenylamine with:
a halide, hydroxide, nitrate, nitrite, sulphate, sulphite, thiosulphate, thiocyanate, isothiocyanate, carbonate, hydrogencarbonate, oxalate, cyanate, cyanide, C₁-C₆ carboxylate or acetylacetate salt of the first metal;
a halide, hydroxide, nitrate, nitrite, sulphate, sulphite, thiosulphate, thiocyanate, isothiocyanate, carbonate, hydrogencarbonate, oxalate, cyanate, cyanide, C₁-C₆ carboxylate or acetylacetate salt of the second metal; and
a catalyst,
   the catalyst being a halide, hydroxide, nitrate, nitrite, sulphate, sulphite, thiosulphate, thiocyanate, isothiocyanate, carbonate, hydrogencarbonate, oxalate, cyanate, cyanide, C₁-C₆ carboxylate or acetylacetate salt of a reducing metal, the reducing metal being a transition metal having a reduction potential of from −0.6 to −1.5 V.

For instance, the invention provides a process for producing a nanostructure (preferably a nanoalloy in the form of a nanowire) wherein the nanostructure comprises:
a first metal which is copper; and
a second metal which is nickel,
   wherein the process comprises treating a fatty species which is oleylamine with:
a halide or acetylacetate salt of the first metal;
a halide or acetylacetate salt of the second metal; and
a catalyst,
   the catalyst being a halide or acetylacetate salt of zinc.

### Reaction Mixture

A mixture comprising a salt of a first metal, a salt of a second metal, a catalyst and a fatty species is referred to as a “reaction mixture”. This name refers to the mixture of a salt of a first metal, a salt of a second metal, a catalyst and the fatty species at all stages of the reaction: thus, “reaction mixture” refers to the mixture prior to the production of any nanostructures, and to the mixture after reaction has occurred and nanostructures have formed. The reaction mixture comprises traces or even larger quantities of each of a salt of a first metal, a salt of a second metal, a catalyst and the fatty species after the formation of nanostructures, as the components tend not to be entirely used up. In the unlikely event that one or more of the salt of the first metal, the salt of the second metal, the catalyst and the fatty species are entirely used up during the reaction, the mixture thus produced is no longer referred to as a “reaction mixture”.

The process of the invention is typically performed in the liquid phase. Typically, therefore, the process of the invention is not a gas-phase process. Where the process of the invention is performed in the liquid phase, at least one of the salt of the first metal, the salt of the second metal, the catalyst and the fatty species is present in the liquid phase, for example in a solution or in the form of a liquid. Preferably, each of the salt of the first metal, the salt of the second metal, the catalyst and the fatty species are present in the liquid phase, for example in solution or in the form of a liquid. Accordingly, the reaction mixture usually comprises a liquid; typically, the reaction mixture is a liquid. In other words, the process of the invention is typically performed in the solution phase.

The reaction mixture typically comprises a non-polar solvent. Non-polar solvents are preferred as they are capable of dissolving the fatty species. Moreover they are unlikely to interfere with the nanostructure formation.

Usually, therefore, the process comprises treating the fatty species in the presence of a non-polar solvent. Suitable non-polar solvents are saturated or unsaturated hydrocarbon solvents. The non-polar solvent may comprise one or more saturated or unsaturated hydrocarbon solvents. Examples of suitable non-polar solvents include C₈-C₂₂ alkanes, C₈-C₂₂ alkenes (including mono-unsaturated or polyunsaturated alkenes), and C₈-C₂₂ alkynes. A preferred example of a suitable non-polar solvent is 1-octadecene.

### Additional Process Steps

The process of the invention usually initially involves dissolving the reactants in a non-polar solvent, where the non-polar solvent is as defined above. This may occur spontaneously at room temperature. However, the dissolution is often slow and so usually it is desirable to accelerate the formation of the reaction mixture. Optionally, therefore, the process of the invention comprises:
(i) heating the reaction mixture at a temperature of 100° C. or less to dissolve the salt of the first metal, the salt of the second metal, the salt of the third metal (where present) and the catalyst.

Where the fatty species is not already dissolved, step (i) may also involve dissolving the fatty species. Once the fatty species, the salt of the first metal, the salt of the second metal, the salt of the third metal (where present) and the catalyst are dissolved, the reaction mixture is formed.

The catalyst accelerates the co-reduction of the first metal salt to the first metal and the second metal salt to the second metal (and also, where present, the third metal salt to the third metal). However, it is often desirable to accelerate the co-reduction process further; in particular, the reaction may be too slow for all practical purposes at room temperature. Usually, therefore, the process comprises:
(ii) heating the reaction mixture at a temperature of 200° C. or less, preferably for a period of from 30 minutes to 10 hours.

After reaction, the reaction mixture typically comprises the nanostructures together with remaining metal salts, catalyst and fatty species. The process therefore optionally comprises one or more purification steps to recover the nano structures. The process may for instance comprise adding a non-polar solvent to the reaction mixture after reaction. Suitable non-polar solvents include C₄-C₁₀ alkanes such as hexane or cyclohexane. Non-polar solvents are useful for dispersing the nanostructures formed during the process. The process may alternatively or additionally comprise adding a polar solvent to the reaction mixture after reaction. Suitable polar solvents include acetone, C₁-C₆ alcohols or water. Non-polar solvents are useful in sequestering excess surfactants and/or fatty species.

Thus, in a preferred embodiment, the process comprises, after step (ii):
(iii) adding a polar solvent and a further non polar solvent to the reaction mixture.

In a further embodiment, the process may optionally comprise a step of removing volatile organic ligands and by-products. A suitable method of removing organic species is to add lactic acid solution (e.g. a few drops of lactic acid solution) to the reaction mixture after the reaction has occurred. Thus, in some embodiments the process of the invention comprises a step of purification by addition of lactic acid. This purification step may be performed one or more times in order to purify the nanostructure products, and may be performed between other purification steps.

Preferably, the process further comprises recovering the nanostructures. A suitable method for recovering the nanostructures comprises:
(iii) adding a polar solvent and a further non polar solvent to the reaction mixture;
(iv) mixing the diluted reaction mixture thus obtained, to facilitate precipitation of the product into the non-polar phase; and
(v) centrifuging the mixed and diluted reaction mixture and decanting the excess liquid.

Steps (iii) to (iv) may be repeated. For instance, the sequence of steps (iii) to (iv) may be performed twice, three times or four times. Steps (iii) to (iv) may be interspersed with other steps such as evaporation of volatile species.

Typically, the process of treating the fatty species with the salt of the first metal, the salt of the second metal and the catalyst is performed under an inert atmosphere, preferably a noble gas atmosphere. Usually, therefore, one or more of the above-described process steps is performed under an inert atmosphere, e.g. a noble gas atmosphere.

In a particularly preferred embodiment of the invention, therefore, is provided a process for producing a nanostructure (preferably a nanoalloy in the form of a nanowire) wherein the nanostructure comprises:
a first metal which is a transition metal having a first reduction potential of from −0.3 V to 1 V; and
a second metal which is a transition metal having a second reduction potential of from −0.3 V to 1 V, the second reduction potential being more negative than the first reduction potential,
   wherein the process comprises treating a fatty species which is selected from C₈-C₂₂ alkylamine and C₈-C₂₂ alkenylamine with:
a non-polar solvent which is selected from C₈-C₂₂ alkanes and C₈-C₂₂ alkenes;
a halide, hydroxide, nitrate, nitrite, sulphate, sulphite, thiosulphate, thiocyanate, isothiocyanate, carbonate, hydrogencarbonate, oxalate, cyanate, cyanide, C₁-C₆ carboxylate or acetylacetate salt of the first metal;
a halide, hydroxide, nitrate, nitrite, sulphate, sulphite, thiosulphate, thiocyanate, isothiocyanate, carbonate, hydrogencarbonate, oxalate, cyanate, cyanide, C₁-C₆ carboxylate or acetylacetate salt of the second metal; and
a catalyst,
   the catalyst being a halide, hydroxide, nitrate, nitrite, sulphate, sulphite, thiosulphate, thiocyanate, isothiocyanate, carbonate, hydrogencarbonate, oxalate, cyanate, cyanide, C₁-C₆ carboxylate or acetylacetate salt of a reducing metal, the reducing metal being a transition metal having a reduction potential of from −0.6 to −1.5 V;
   the process comprising:
(i) heating the reaction mixture at a temperature of 100° C. or less to dissolve the salt of the first metal, the salt of the second metal and the catalyst;
(ii) heating the reaction mixture at a temperature of 200° C. or less, for a period of from 30 minutes to 10 hours; and
   purifying the nanostructures thus produced.

For instance, the invention provides a process for producing a nanostructure (preferably a nanoalloy in the form of a nanowire) wherein the nanostructure comprises:
a first metal which is copper; and
a second metal which is nickel,
   wherein the process comprises treating a fatty species which is oleylamine with:
1-octadecene;
a halide or acetylacetate salt of the first metal;
a halide or acetylacetate salt of the second metal; and
a catalyst, the catalyst being a halide or acetylacetate salt of zinc;
   the process comprising:
(i) heating the reaction mixture at a temperature of 100° C. or less to dissolve the salt of the first metal, the salt of the second metal and the catalyst;
(ii) heating the reaction mixture at a temperature of 200° C. or less, for a period of from 30 minutes to 10 hours;
(iii) adding a polar solvent and a further non polar solvent to the reaction mixture;
(iv) mixing the diluted reaction mixture thus obtained, to facilitate precipitation of the product into the non-polar phase; and
(v) centrifuging the mixed and diluted reaction mixture and decanting the excess liquid.

The nanostructures recovered from the reaction mixture, by the process described above or by other means, are suitable for use in applications as described hereafter.

### Process for Producing a Nanoalloy

The process of the invention can surprisingly be tuned to produce different products by varying the nature of the catalyst. i.e. by varying the nature of the salt of the reducing metal.

The catalyst comprises a metal ion and a counterspecies. Typically, the metal ion is a cation of the reducing metal, such as an M⁺, M²⁺ or M³⁺ ion where M indicates the reducing metal. However, it is envisaged that the metal ion may alternatively be present in the form of a complex ion carrying a negative charge, such as an MO⁻, MO₂⁻, MO₃⁻, or MO₄⁻, ion, where M indicates the reducing metal. Most usually, however, the metal ion of the catalyst is a monatomic, positively-charged ion of the reducing metal.

The counterspecies of the catalyst complements the metal ion. Thus, where the catalyst comprises a positively-charged metal ion, the counterspecies comprises a negative charge. However, where the catalyst comprises a complex ion carrying a negative charge, the counterspecies comprises a positive charge.

The process of the invention is capable of producing nanoalloys, particularly nanoalloys in the form of nanowires. The meaning of the term “nanoalloy” is discussed in more detail below. Nanoalloys are advantageous products due to their stability and tunable electrical and catalytic properties. Without wishing to be bound by theory, it is speculated that the surprising ability of the process of the invention to produce true nanoalloys may be due to the ability of the catalyst to enable simultaneous reduction of the first metal salt and the second metal salt (and, where present, the third metal salt).

In a preferred embodiment, therefore, the process comprises reducing the salt of the first metal and the salt of the second metal simultaneously. In a particular aspect of this embodiment, the process comprises simultaneously reducing a salt of the first metal, a salt of the second metal and a salt of the third metal.

Formation of nanoalloys has in particular been observed where the catalyst comprises a counterspecies which is small and anionic. It is speculated that the small anionic counterspecies may influence the structure of a reduction complex formed during reaction to promote simultaneous reduction of metals.

Accordingly, in a particularly preferred embodiment, the catalyst comprises a metal cation and a counterspecies, the counterspecies being an anion consisting of one, two or three atoms. In this embodiment, the process of the invention produces a nanoalloy. In a particularly preferred aspect of this embodiment, the catalyst comprises a counterspecies which is an anion that consists of one atom. Preferably the anion is a halide ion, particularly preferably a chloride ion.

In this embodiment, therefore, the catalyst is preferably a salt comprising a monatomic cation of a transition metal having a reduction potential of from −0.6 to −1.5 V and a counterspecies which is an anion consisting of one, two or three atoms. For example, the catalyst may be a halide, hydroxide, cyanate, or cyanide salt (preferably a halide salt) of a transition metal having a reduction potential of from −0.6 to −1.5 V. Particularly preferably the catalyst may be a halide salt of zinc, for instance zinc chloride.

In some embodiments of the invention is provided a process for producing a nanoalloy (preferably in the form of a nanowire) wherein the nanoalloy comprises:
a first metal which is a transition metal having a first reduction potential of from −0.3 V to 1 V; and
a second metal which is a transition metal having a second reduction potential of from −0.3 V to 1 V, the second reduction potential being more negative than the first reduction potential,
   wherein the process comprises treating a fatty species which is selected from C₈-C₂₂ alkylamine and C₈-C₂₂ alkenylamine with:
a halide, hydroxide, nitrate, nitrite, sulphate, sulphite, thiosulphate, thiocyanate, isothiocyanate, carbonate, hydrogencarbonate, oxalate, cyanate, cyanide, C₁-C₆ carboxylate or acetylacetate salt of the first metal;
a halide, hydroxide, nitrate, nitrite, sulphate, sulphite, thiosulphate, thiocyanate, isothiocyanate, carbonate, hydrogencarbonate, oxalate, cyanate, cyanide, C₁-C₆ carboxylate or acetylacetate salt of the second metal; and
a catalyst,
   the catalyst being a halide, cyanate, or cyanide salt of a reducing metal, the reducing metal being a transition metal having a reduction potential of from −0.6 to −1.5 V.

Thus, in an exemplary process of the invention is provided a process for producing a nanoalloy, preferably in the form of a nanowire, wherein the nanoalloy comprises:
a first metal which is copper; and
a second metal which is nickel,
   wherein the process comprises treating a fatty species which is oleylamine with:
a halide or acetylacetate salt of the first metal;
a halide or acetylacetate salt of the second metal; and
a catalyst,
   the catalyst being a halide salt of zinc, preferably zinc chloride.

### Process for Producing a Core-Shell Structure

The process of the invention is capable of producing nanostructures having a core-shell structure. Core-shell structures are discussed in more detail below. Briefly, core-shell structures produced by the process of the invention comprise an inner core of the first metal surrounded by a shell of the second metal. Such core-shell nanostructures may further comprise an outer shell of the third metal. Although core-shell structures are known, the process of the present invention can produce these structures more easily by using a catalyst.

The process of the invention can be tuned to produce core-shell nanostructures by selection of an appropriate counterspecies for the catalyst. Core-shell nanostructures are favoured by larger counterspecies. In particular, core-shall nanostructures are formed when the counterspecies is not a halide ion, for instance when the counterspecies comprises four or more atoms.

Thus, in one aspect the invention provides a process for nanostructure comprises a core of the first metal and a shell of the second metal, wherein the catalyst comprises a counterspecies which is not a halide ion. In a preferred aspect of this embodiment, the counterspecies comprises four or more atoms.

Exemplary counterspecies suitable for producing core-shell nanostructures include C₃-C₆ alcohol, deprotonated C₃-C₆ alcohol, C₁-C₈ carboxylic acid, C₁-C₈ carboxylate, C₂-C₈ ketone, deprotonated C₂-C₈ ketone, C₃-C₁₂ diketone, deprotonated C₃-C₁₂ diketone, CO, or C₂-C₆ nitrile, preferably acetylacetonate. In a preferred embodiment, the process of the invention is a process for producing a core-shell nanostructure wherein the catalyst comprises a metal cation and an anion selected from deprotonated C₃-C₆ alcohol, C₁-C₈ carboxylate, and deprotonated C₃-C₁₂ diketone, preferably acetylacetonate or acetate.

In this embodiment, therefore, the catalyst is preferably a salt comprising a monatomic cation of a transition metal having a reduction potential of from −0.6 to −1.5 V and a counterspecies which is deprotonated C₃-C₆ alcohol, C₁-C₈ carboxylate, and deprotonated C₃-C₁₂ diketone. For example, the catalyst may be a C₁-C₈ carboxylate, acetylacetonate or acetate salt (preferably a acetylacetonate salt) of a transition metal having a reduction potential of from −0.6 to −1.5 V. Particularly preferably the catalyst may be a C₁-C₈ carboxylate salt of zinc, for instance zinc acetylacetonate.

In some embodiments of the invention is provided a process for producing a core-shell nanostructure wherein the nanostructure comprises:
a first metal which is a transition metal having a first reduction potential of from −0.3 V to 1 V; and
a second metal which is a transition metal having a second reduction potential of from −0.3 V to 1 V, the second reduction potential being more negative than the first reduction potential,
   wherein the process comprises treating a fatty species which is selected from C₈-C₂₂ alkylamine and C₈-C₂₂ alkenylamine with:
a halide, hydroxide, nitrate, nitrite, sulphate, sulphite, thiosulphate, thiocyanate, isothiocyanate, carbonate, hydrogencarbonate, oxalate, cyanate, cyanide, C₁-C₆ carboxylate or acetylacetate salt of the first metal;
a halide, hydroxide, nitrate, nitrite, sulphate, sulphite, thiosulphate, thiocyanate, isothiocyanate, carbonate, hydrogencarbonate, oxalate, cyanate, cyanide, C₁-C₆ carboxylate or acetylacetate salt of the second metal; and
a catalyst,
   the catalyst being a C₁-C₈ carboxylate, acetylacetonate or acetate salt of a reducing metal, the reducing metal being a transition metal having a reduction potential of from −0.6 to −1.5 V.

Thus, in an exemplary process of the invention is provided a process for producing a core-shell nanostructure, wherein the core-shell nanostructure comprises:
a first metal which is copper; and
a second metal which is nickel,
   wherein the process comprises treating a fatty species which is oleylamine with:
a halide or acetylacetate salt of the first metal;
a halide or acetylacetate salt of the second metal; and
a catalyst,
   the catalyst being zinc acetylacetonate.

In a particularly preferred aspect of this embodiment, the counterspecies comprises six or more atoms. The counterspecies is preferably acetylacetonate.

### Quantities of Materials

Typically, the fatty species is present in excess. That is, typically the fatty species is present in a molar excess when compared to the total molar quantity of the first metal and the second metal. usually, the fatty species may be present in a 10× molar excess compared to the total molar quantity of the first metal and the second metal. By this is meant that the molar quantity of the fatty species in the reaction mixture is ten or more times larger than the total molar amount of the first metal and the second metal in the reaction mixture. For instance, the fatty species may be present in a 50× molar excess or a 100× molar excess or a 1000× molar excess.

The molar ratio of the first metal and the second metal provided to the fatty species (corresponding to their initial ratio in the reaction mixture) is variable. The molar ratio of the first metal to the second metal may be, for instance, from 100:1 to 1:100. Usually, the molar ratio of the first metal to the second metal is, for instance, from 10:1 to 1:10, e.g. from 5:1 to 1:5 or 2:1 to 1:2.

Where a third metal is present, the molar ratio of the first metal, the second metal and the third metal provided to the fatty species (corresponding to their initial ratio in the reaction mixture) is variable. The molar ratio of the first metal to the third metal may be, for instance, from 100:1 to 1:100. Usually, the molar ratio of the first metal to the third metal is, for instance, from 10:1 to 1:10, e.g. from 5:1 to 1:5 or 2:1 to 1:2. Similarly, the molar ratio of the second metal to the third metal may be, for instance, from 100:1 to 1:100. Usually, the molar ratio of the second metal to the third metal is from 10:1 to 1:10, for instance, from 10:1 to 1:10, e.g. from 5:1 to 1:5 or 2:1 to 1:2.

As will be appreciated, the catalyst is provided to the fatty species in a non-negligible quantity in relation to the molar quantities of the first metal, the second metal and (where present) the third metal. The molar ratio of the reducing metal to the first metal (provided to the fatty species) is generally at least 0.1:1. Usually, the molar ratio of the reducing metal to the first metal is at least 0.3:1. Preferably the molar ratio of the reducing metal to the first metal is at least 0.5:1, for example at least 0.8:1 or at least 1:1. Generally the molar ratio of the reducing metal to the first metal is less than 5:1, for instance is less than 3:1.

The molar ratio of the catalyst to the total molar quantity of the first metal and the second metal provided to the fatty species is generally at least 0.05:1. Usually, the molar ratio of the catalyst to the total molar quantity of the first metal and the second metal is at least 0.2:1, preferably at least 0.3:1 or at least 0.5:1. Generally molar ratio of the catalyst to the total molar quantity of the first metal and the second metal is less than 3:1, for instance is less than 2:1.

### Products Obtainable by the Process

The invention provides products which are obtainable by and/or obtained by the processes described herein. Thus, the invention provides a nanostructure obtainable or obtained by, preferably obtainable by, a process as described herein. In a preferred aspect of this embodiment, the invention provides a nanoalloy obtainable or obtained by, preferably obtainable by, a process as described herein. In another preferred aspect of this embodiment, the invention provides a core-shell nanostructure obtainable or obtained by, preferably obtainable by, a process as described herein.

The nanoalloy and core-shell nanostructures obtainable by the process of the invention are described hereafter. Briefly, it should be noted that particularly preferred nanostructures obtainable by the process of the invention include nanostructures comprising a first metal which is copper and a second metal which is nickel. For instance, preferred nanostructures include nanoalloys of copper and nickel; and core-shell nanostructures comprising a nickel core and a copper shell.

The shape of the nanostructures obtainable by the processes of the invention is not particularly limited. In one aspect, the nanostructure obtainable by the process of the invention is in the form of a nanowire or nanodisc, preferably a nanowire.

### Nanoalloy

The invention provides a true nanoalloy. A nanoalloy is an alloy having a nanostructure. The term “nanostructure” as used herein indicates a structure having at least one dimension of from 1 nm to 1 μm in size. The term “alloy” as used herein has its usual meaning in the art: a mixture of two or more metals.

A nanoalloy differs from a core-shell nanostructure in that the chemical composition of the nanoalloy does not vary throughout its structure. By contrast, a core-shell nanostructure comprises at least two different regions of varying chemical composition: a core, consisting mostly or entirely of a first metal and a shell around the core consisting mostly or entirely of a second metal. That is, a core-shell structure comprises a core wherein the ratio of the concentration of the first metal to the concentration of the second metal (M1/M2) is large, and shell wherein the ratio M1/M2 is small. By contrast, in a true nanoalloy the ratio M1/M2 is approximately constant throughout the extent of the nanoalloy.

The true nanoalloy (particularly in the form of a nanowire) is highly advantageous in comparison to core-shell nanostructures for a variety of reasons. Firstly, a true nanoalloy consists of a single metallic phase, rather than regions of differing metallic composition. Thus, the electronic, electrochemical, magnetic and catalytic properties of the nanoalloy are (i) uniform throughout the nanoalloy and (ii) truly intermediate between those of the constituent metals, rather than varying throughout the nanostructure as the metallic composition varies. The properties of the nanoalloy can therefore be adjusted by varying the concentration and nature of the constituent metals to create a nanomaterial having properties different from those of the constituent metals.

Furthermore, the true nanoalloy is more stable than the core-shell nanostructure. The inventors have observed that core-shell nanostructures (such as nanowires having a copper core and a nickel shell) have a labile outer shell. Thus, the nickel shell of copper-nickel nanowires is susceptible to rapid oxidation and elevated concentrations of oxide are observed within the core-shell nanostructure shortly after its formation. By contrast, the nanowires comprising a true copper-nickel nanoalloy were not seen to be susceptible to ingress of oxygen. An external coating of oxide was observed after storage of the copper-nickel nanoalloys, but oxygen did not appear to penetrate into the nanoalloy itself. Thus, nanoalloys may be considerably more stable than core-shell structures.

The invention therefore provides a nanoalloy comprising:
a first metal having a first reduction potential; and
a second metal having a second reduction potential, the second reduction potential being more negative than the first reduction potential.

In another aspect, the invention provides a nanoalloy further comprising a third metal having a third reduction potential, the third reduction potential being more negative than the second reduction potential.

The first, second and third metals (and the corresponding first, second and third reduction potentials) are as defined above.

The nanoalloys of the invention advantageously do not require the presence of a noble metal. The nanoalloys of the invention exhibit electronic and catalytic properties similar to those of noble metals without requiring the presence of noble metals, thus offering a cheaper alternative to products comprising noble metals. In a preferred embodiment, the nanoalloy of the invention comprises at least one non-noble metal.

In a preferred aspect, one or more of the first, second and (where present) third metals is a non-noble transition metal. For instance, one or more of the first, second and (where present) third metals may be selected from the transition metals excluding platinum, palladium, gold and silver. In a further example of this embodiment, one or more of the first, second and (where present) third metals may be selected from the transition metals excluding platinum, palladium, gold, silver, ruthenium, osmium, rhodium and iridium.

In a further aspect of this embodiment, the first, second and (where present) third metals may all be selected from the transition metals excluding platinum, palladium, gold and silver. In a further example of this embodiment, each of the first, second and (where present) third metals may be selected from the transition metals excluding platinum, palladium, gold, silver, ruthenium, osmium, rhodium and iridium.

In a particularly preferred embodiment, the first metal is copper and/or the second metal is nickel.

The true nanoalloy of the invention is distinguished from known core-shell nanostructures by its substantially uniform distribution of the first, second and (where present) third metals.

The nanoalloy of the invention may be described as consisting of a single phase which is a solid solution of the first, second and optionally the third metal. In this embodiment, the atoms of the first, second and (where present) third metals are distributed randomly throughout the alloy. Thus, any spatial region of the nanoalloy will on average have a metal composition which is approximately the same, or exactly the same, as any other spatial region of the nanoalloy. By “metal composition” is meant the concentration of each of the first metal, the second metal and (where present) the third metal.

The nanoalloy comprises a substantially uniform spatial distribution of the first metal, the second metal, and where present the third metal throughout the nanoalloy.

Preferably, the nanoalloy comprises a region of uniform spatial distribution of the first metal, the second metal, and where present the third metal, said region being at least 100 nm³ in volume.

The approximately uniform spatial distribution of metals throughout the nanoalloy preferably meets one or more of the following requirements. In the following, M1 is the concentration of the first metal, M2 is the concentration of the second metal and M3 is the concentration of the third metal.

Preferably, the ratio M1/M2 varies by less than 5% along at least one dimension of the nanoalloy. Typically the ratio M1/M2 varies by less than 1% along at least one dimension of the nanoalloy. For instance, the ratio M1/M2 varies by less than 5% across all dimensions of the nanoalloy. In one aspect of this embodiment, where the nanoalloy is in the form of a nanowire, the ratio M1/M2 varies by less than 5% across the diameter of the nanowire. For instance, the ratio M1/M2 varies by less than 5% along the length of the nanowire, or by less than 5% along the length and across the diameter of the nanowire.

In a further aspect the nanoalloy comprises a third metal, and the ratios M1/M3 and M2/M3 vary by less than 5% along at least one dimension of the nanoalloy. Typically the ratios M1/M3 and M2/M3 vary by less than 1% along at least one dimension of the nanoalloy. For instance, the ratios M1/M3 and M2/M3 vary by less than 5% across all dimensions of the nanoalloy. In one aspect of this embodiment, where the nanoalloy is in the form of a nanowire, the ratios M1/M3 and M2/M3 vary by less than 5% across the diameter of the nanowire. For instance, the ratios M1/M3 and M2/M3 vary by less than 5% along the length of the nanowire, or by less than 5% along the length and across the diameter of the nanowire.

In a particularly preferred aspect of the nanoalloy of the invention, the nanoalloy comprises a crystalline face. This aspect is highly preferred because the crystalline face exposes a particular type or types of catalytic site and may therefore be useful in controlling catalytic activity. Furthermore, the crystal face is an advantageously stable arrangement which is more resistant to corrosion (for instance to oxidation) than less stable non-crystalline arrangements, which may comprise a higher concentration of defects and reactive sites.

Thus, preferably the nanoalloy is monocrystalline. That is, in a preferred embodiment the nanoalloy of the invention comprises a single crystal. The single crystal is advantageous as it is usually stable, durable and resistant to corrosion, for instance by acid attack and oxidation.

### Shape of Nanoalloy

The nanoalloys of the invention are nanostructures. Thus, they comprise at least one dimension which is from 1 nm to 1 μm in size. However, the other dimensions of the nanoalloys of the invention are not particularly limited and may vary considerably depending on whether the nanoalloy in question is a nanowire, a nanodisc, or another type of nanostructure.

In most embodiments, the nanoalloy of the invention has a largest dimension of at least 500 nm. Generally, the largest dimension of the nanoalloy is 10 μm or larger, preferably 200 μm or larger and preferably less than 1000 μm.

In most embodiments, the nanoalloy of the invention has a smallest dimension which is less than 1 μm. In most embodiments, the smallest dimension of the nanoalloy is at least 1 nm. Typically, the smallest dimension of the nanoalloy of the invention is 500 nm or less; and is preferably 200 nm or smaller and greater than 1 nm.

In a particularly preferred embodiment, the nanoalloy may be in the form of a nanowire. The process of the invention can conveniently produce true nanoalloys in the form of nanowires.

For instance, the nanoalloy may be in the form of a nanowire having a diameter of from 1 nm to 500 nm and a length of from 10 μm to 1000 μm.

In another preferred embodiment, the nanoalloy may be in the form of a nanodisc. For instance, the nanoalloy may be in the form of a nanodisc having a diameter of from 10 μm to 1000 μm and a thickness (corresponding to the height of the cylinder formed by the nanodisc) of from 1 nm to 500 nm.

Preferably, the ratio of the largest dimension to the smallest dimension of the nanoalloy is 10 or more. For example, the ratio of the largest dimension to the smallest dimension of the nanoalloy may be at least 20 or at least 50. For instance, where the nanoalloy is in the form of a nanodisc, the diameter of the nanodisc may be at least 10, 20 or 50 times as large as its thickness. Similarly, where the nanoalloy is in the form of a nanowire, the length of the nanowire may be at least 10, 20 or 50 times larger than the diameter of the nanowire. Further preferably, the ratio of the largest dimension to the smallest dimension of the nanoalloy is 1000 or less, for instance 500 or less. Thus, typically, where the nanoalloy is in the form of a nanowire, the length of the nanowire may be from 10 to 1000 times its diameter. Also typically, where the nanoalloy is in the form of a nanodisc, the diameter of the nanodisc may be from 10 to 1000 times its thickness.

### Composition of Nanoalloy

The first metal, the second metal and (where present) the third metal in the nanoalloy are as defined above in relation to the process of the invention.

The nanoalloy typically comprises a first metal and a second metal. The content of the first metal relative to the content of the second metal in the nanoalloy is not particularly limited. Usually, the ratio of the number of atoms of the first metal to the number of atoms of the second metal in the nanoalloy is from 5:1 to 1:5, preferably from 2:1 to 1:2, most preferably 1:1.

The nanoalloy may optionally comprise a third metal. The content of the third metal relative to the content of the first and second metals in the nanoalloy is not particularly limited. Usually, where the nanoalloy comprises a third metal:
the ratio of the number of atoms of the first metal to the number of atoms of the third metal in the nanoalloy is from 5:1 to 1:5, preferably from 2:1 to 1:2, most preferably 1:1; and
the ratio of the number of atoms of the second metal to the number of atoms of the third metal in the nanoalloy is from 5:1 to 1:5, preferably from 2:1 to 1:2, most preferably 1:1.

The nanoalloy of the invention typically further comprises impurities such as oxide ions. The nanoalloy may also comprise traces of the catalyst used to produce the nanoalloy (if any), derivatives of organic species and ligands used in the preparation of the nanoalloy. It is possible to remove organic species by evaporation and so the concentration of any impurities arising from volatile organic species is usually low. Therefore where impurities are present, the majority of impurities in the nanoalloys of the invention is usually oxide-based.

The total amount of impurities in the nanoalloy is typically less than 10% by weight, for instance less than 5% by weight, less than 2% by weight, less than 1% by weight or less than 0.5% by weight. Impurities may be oxide species, for example oxide ions, as mentioned above; however, impurities may also comprise other metal or salt species such as sulphides.

As discussed above, the nanoalloys of the invention are typically resistant to oxidation and therefore often have a high degree of purity. This is particularly the case where the nanoalloy is monocrystalline. Thus, typically, the nanoalloy comprises at least 90% metal by weight. Preferably the nanoalloy comprises at least 95% metal by weight, more preferably at least 99% metal by weight, for instance about 99.5% or about 100% metal by weight.

Usually the nanoalloy comprises less than 10% oxygen by weight. Preferably the nanoalloy of the invention comprises less than 5% oxygen by weight, more preferably less than 1% oxygen by weight, for instance about 0.5% or about 0% oxygen by weight.

### Properties of Nanoalloys

The nanoalloys of the invention can be modified in terms of their constituent metals, and the relative composition of those metals, to produce nanoalloys having particular electrochemical properties. In a preferred embodiment, the invention provides a nanoalloy having an overpotential with respect to the hydrogen evolution reaction is less than 0.6 V, preferably less than 0.5 V. In a preferred aspect of this embodiment the nanoalloy comprises a first metal which is copper and a second metal which is nickel and the ratio of the number of copper atoms to the number of metal atoms in the nanoalloy is from 1.5:1 to 1:1.5, preferably from 1.2:1 to 1:1.2.

Moreover, the nanoalloys of the invention can have advantageous optical properties. In particular, the colour of the nanoalloys of the invention may be tuned by adjusting their chemical composition. For instance, known copper nanowires have a bright orange-pink colour. By contrast, copper-nickel nanoalloys in the form of nanowires have a grey colour which makes them more suitable for use as a transparent conductor.

### Nanoalloy Including Oxide Coat

As discussed above the nanoalloys of the invention are typically resistant to corrosion, for example to oxidation. Oxide coatings frequently form on the surface of the nanoalloys of the invention during formation and storage of the nanoalloys. However, the oxide ions do not diffuse far into the nanoalloy itself; rather, they form a coating upon the surface of the nanoalloy. Thus, in one embodiment, the nanoalloy of the invention comprises an oxide coating, particularly a protective oxide coating.

In some aspects, therefore, the invention provides an oxide-coated nanoalloy comprising:
a nanoalloy as defined above; and
a coating on the surface of the nanoalloy comprising a metal oxide.

The metal oxide typically comprises an oxide of the first metal and/or an oxide of the second metal. Where the nanoalloy comprises a third metal, the metal oxide may additionally comprise an oxide of the third metal.

The oxide coating typically has an average thickness of from 0.1 nm to 50 nm, particularly from 0.1 to 20 nm. The oxide-coated nanoalloy typically comprises 20% oxygen by weight or less, preferably 10% oxygen by weight or less, for example 5% oxygen by weight or less.

### Process for Producing Product

As discussed above, the process of the invention can be used to produce nanoalloys as described herein. The invention therefore provides a process as described herein for producing a nanoalloy as described herein.

The process of the invention may further produce an oxide-coated nanoalloy as described above. For instance, the process may comprise producing a nanoalloy as described herein and contacting said nanoalloy with an oxygen-containing environment. Thus, the invention further provides a process as described herein for producing an oxide-coated nanoalloy as described herein.

### Derivative Products and Uses

The nanoalloys of the invention have tunable electrical, electrochemical, optical, optoelectronic and catalytic properties which make them useful for a variety of applications. In particular, the nanoalloys of the invention (such as copper-nickel nanoalloys) have electrochemical and catalytic properties similar to those of platinum. Hence, these nanoalloys offer a cheaper alternative to platinum in applications where platinum is traditionally used, for instance in hydrogen storage and hydrogen evolution.

In one aspect, the invention provides a hydrogen storage module comprising a nanoalloy as defined herein and/or an oxide-coated nanoalloy as defined herein.

In one aspect, the invention provides a transparent conductor comprising a nanoalloy as defined herein and/or an oxide-coated nanoalloy as defined herein.

In one aspect, the invention provides the use of a nanoalloy as defined herein and/or an oxide-coated nanoalloy as defined herein in a method of hydrogen storage.

In one aspect, the invention provides the use of a nanoalloy as defined herein and/or an oxide-coated nanoalloy as defined herein as a hydrogen storage material in a method of hydrogen storage.

In one aspect, the invention provides the use of a nanoalloy as defined herein and/or an oxide-coated nanoalloy as defined herein in the manufacture of a transparent conductor.

In one aspect, the invention provides the use of a nanoalloy as defined herein and/or an oxide-coated nanoalloy as defined herein as a transparent conductor.

In one aspect, the invention provides the use of a nanoalloy as defined herein and/or an oxide-coated nanoalloy as defined herein as a catalyst.

### Examples

### Methods and Materials

Comparative synthesis example—Copper nanowires: Copper nanowires were synthesised using a modified version of the method reported by Guo et al in “Copper Nanowires as Fully Transparent Conductive Electrodes”, Sci. Rep. 3 (2013). In a typical procedure, 2.4 mmol of CuCl₂.2H₂O, 1 mmol of Ni(acac)₂, 20 mL of oleylamine (OLA) and 5 mL of octadecene (ODE) were added to a three neck round bottomed flask with a Liebig condenser attached. Under a gentle flow of argon, the mixture was first heated up at 80° C. until all the precursors had dissolved and then heated to 180° C. for 3 h. After reaction, the mixture was left to cool to room temperature. 20 mL of hexane was added to the mixture and transferred to a 50 mL vial. A 1:1 mix of a non-polar/polar (acetone/hexane) solvents was then added. Acetone helps to remove excess surfactant while hexane is a good solvent for dispersing nanowires. The mixture was then vortex mixed and sonicated for 5 min and centrifuged at 6000 rpm for 5 min several times to remove the excess of ligands. The cleaning process was repeated three times. Copper nanowires were finally re-dispersed in toluene and stored in a N₂ environment.

Comparative synthesis example—nickel nanowires: In a typical synthesis, 2.1 mmol of NiCl₂, 0.8 mmol of Zn(acac)₂, 15 ml of OLA and 5 ml of 1-octadecene (ODE) were added to a three-neck flask and the synthesis was carried out in the same way as the copper nanowire synthesis described above.

Copper nickel core-shell synthesis: In a typical synthesis, 2.4 mmol of CuCl₂.2H₂O and 1 mmol of Ni(acac)₂, 2.9 mmol of Zn(acac)₂, 20 mL of OLA and 5 ml ODE are added to a three-neck flask. The reaction is carried out in the same fashion as the copper nanowire synthesis described above.

Copper-nickel nanoalloy synthesis: In a typical synthesis, 2.4 mmol of CuCl₂.2H₂O and 1 mmol of Ni(acac)₂, 2.9 mmol of ZnCl₂, 20 mL of OLA and 5 ml ODE are added to a three-neck flask. The reaction is carried out in the same way as the copper nanowire synthesis described above.

TEM and STEM preparation: To assess the morphology of the nanowires, and to determine their composition and their crystallinity, the nanowires produced as discussed above were examined using a JEOL 2010 TEM, with EDX capability, operating at 200 kV and the Oxford JEOL 2200MCO Aberration Corrected, Monochromated FEG-TEM operating at 200 kV. The JEOL 2200MCO was operated and was used to obtain higher resolution images. Scanning transmission electron microscopy (STEM) was used to obtain elemental mapping and line scans of NW composition and elements distribution via Energy Dispersive X-ray Spectroscopy (EDX). They were performed using both the JEOL 2100 with LAB6 source and the JEOL 2200MCO Aberration Corrected, Monochromated FEG-TEM operating at 200 kV. TEM samples were prepared by making dilute dispersions of nanowires and drop casting a few micro-liters on a lacy carbon coated Au grid that was dried in ambient conditions. No additional treatments were performed unless specified.

SEM preparation: SEM images were taken using a JEOL JSM-840F Scanning Electron Microscope (SEM), equipped with a cold cathode field emission gun, at a voltage of 5 kV. Typically, copper and copper nickel nanowires were drop cast onto a 10×10 mm² silicon chip glued on a 12.5 diameter metal holder. A 3 nm platinum coating was deposited on top of the nanowires to render the film conductive. Images acquired by SEM were used to assess the nanowires' quality as well as determining the averaged aspect ratio of about 100 synthesized copper and copper nickel nanowires.

HER procedure: Nanowires synthesised as discussed herein were investigated as materials for the hydrogen evolution reaction (HER). All electrochemical measurements were carried out in a three-electrode cell using a Multi Potentiostat VMP3 from Bio-Logic. The reference was an Ag/AgCl electrode in saturated KCl. Copper nanowires, nickel nanowires, copper-nickel nanoalloy nanowires having a 1:1 Cu:Ni ratio and core-shell copper-nickel nanowires were cleaned using a solution of lactic acid and were deposited on a nitric acid pre-treated 1 cm×1 cm glassy carbon. The acid treatment helped to improve the adhesion between the substrate and the nanowires. Cyclic voltammetry scans were performed at 100, 50, 20, and 10 scan rates to determine the surface area. Samples were first electrochemically purged in N₂-purged 1 M HClO₄⁻ (pH=1) for 10 min. Linear scan voltammetry (LSV) were taken between 0.25V to −0.25 V at a sweep rate of 5 mV/s. The LSV was used to measure the Tafel slope and current density for each sample.

The Tafel equation which is defined for overpotential 11 higher to 0.5V, is expressed as:

$$η = a + b log ( j ) \\ Where b = \frac{2.3 R T}{α nF} and a = - \frac{2.3 RT}{α nF} log ( {j}_{0} ) \qquad ( 1 )$$

With log(j₀) being the current density and

$$\frac{2.3 R T}{α nF}$$

being the Tafel slope.

The LSV generated during the HER measurement were plotted in the form of the overpotential, η, vs. log(j) in order to determine the Tafel slope.

The overpotential is defined as the difference between the potential E at which the reaction takes place and E_{HER}, the reversible hydrogen electrode (RHE) potential given by the Nernst equation. The resulting graph is known as a Tafel plot, and a and b can be determined by fitting the linear portion of the plot. The intercept will be then used to determine the current density j₀.

### Results and Discussion

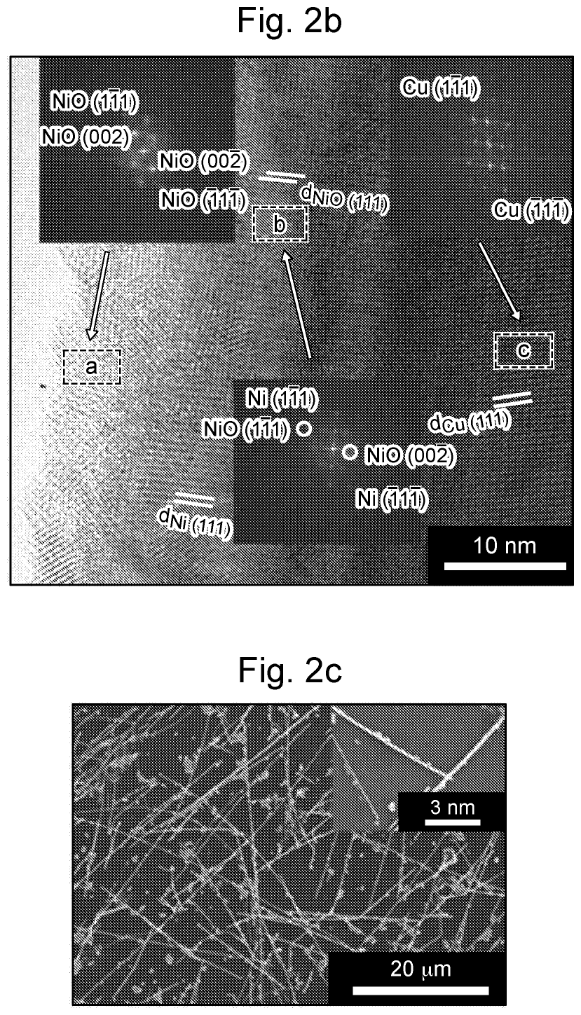

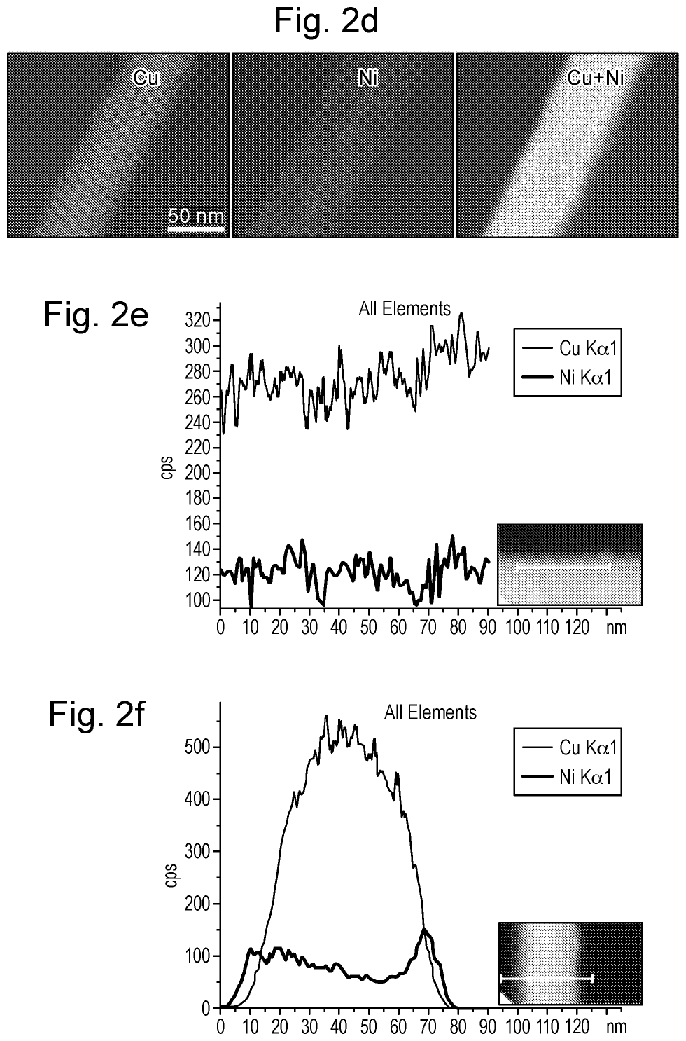

The HR-TEM micrograph displayed in FIG. 2(a), shows a portion of a copper-nickel core-shell nanowire synthesised with the presence of a Zn(acac)₂ catalyst. It can be seen that the metal composition of the nanowire changes across its diameter. Two regions can be distinguished: a low contrast region on the edges of the nanowire, most likely corresponding to the Ni shell, and a high contrast region in the middle which is attributed to the Cu core. The difference in contrast observed is due to a difference of thickness between the Cu core and the thinner Ni shell wrapping it. A detailed analysis of the edge of the wire is represented in FIG. 2(b) which shows the evolution of the crystalline structure across the nanowire. The FFT is taken in three different areas labelled a, b and c in FIG. 2(b). The FFT of zone a suggests a cubic symmetry with a lattice spacing of d111=0.24 nm which corresponds to NiO. In zone b, the FFT shows that both NiO and Ni phases are present with Ni lattice spacing of d111=0.21 nm. The FFT of zone c reveals the presence of a highly ordered cubic phase composed only of Cu with a lattice spacing d111=0.20 nm. In case of core-shell CuNi nanocrystals, it has been shown by Yamauchi et al (Nanoscale 2 515-523 (2010)) that, in the case where nickel content exceeds 40%, a very thin layer attributed to NiO is formed on the surface of bimetallic copper-nickel nanoparticles. However, for copper-nickel core-shell nanowires, this is the first time that an oxide shell has been seen. It is surmised that the core-shell nanowire outer layer is made of a Ni oxide that diffuses through the Ni shell. This observation hints that the wire might progressively become a NiO/Cu core shell. Consequently, it appears that the nickel shell is insufficient to protect the wire against oxidation through time.

Corresponding EDX images of Cu, Ni and CuNi of the core-shell structure represented in FIG. 2(c). Two distinctive regions can be observed with the Cu concentrated in the middle of the wire and Ni in the outer layers. This confirms further the presence of two distinctive regions, hinting that the nanowire formed comprises a Cu core and an Ni shell. The images show also that Ni diffuses through the Cu core creating mixture of metals in the centre. This has been observed previously (Rathmell et al, Nano Letters 12, 3193-3199 (2012)). Ni and Cu are miscible in all proportions which explains the interdiffusion between these two elements. The nickel count is constant through the whole nanowire, which is due to the fact that the shell wraps the entire nanowire.

Line scans collinear with and perpendicular to the axis along the length of the nanowire are performed and shown in FIGS. 2(d) and 2(e) respectively. The copper composition is higher in the centre of the nanowire while Ni is present in lower quantities and does not vary much along the diameter of the nanowire. This suggests that the amount of Ni is approximately the same across the wire. The mechanism of formation of the core-shell can therefore be explained as follows. First, copper is formed and reduction of Cu²⁺ ions occurs, leading to the growth of copper nanowires. Subsequently, Ni²⁺ is reduced to Ni⁰. Once the concentration of Ni⁰ exceeds the critical concentration, the Ni atoms begin to accumulate on the surface of the wire. It is found that changing the stirring speed does not affect the morphology of the wire; the wire is always rough. The roughness of the wire is another hint that Ni is forming on top of Cu.

Therefore, nanowires synthesised using Zn(acac)₂ as a precursor possess a Cu_{core} Niₛₕₑₗₗ structure. These core-shell show the presence of an oxide that diffuses through the shell layer indicating that the nanowire composition will vary with time.

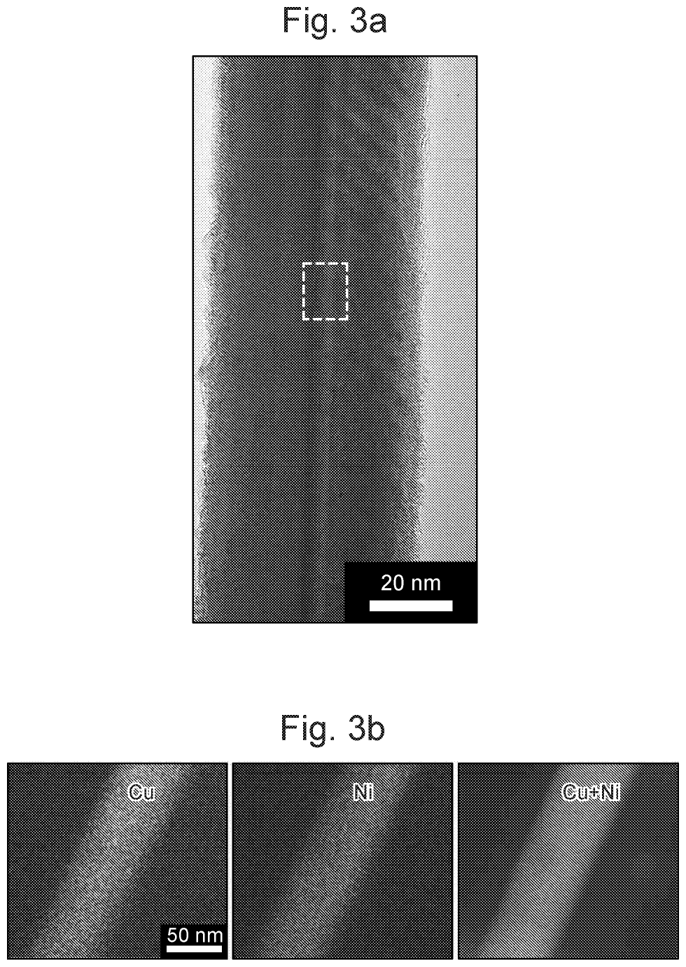

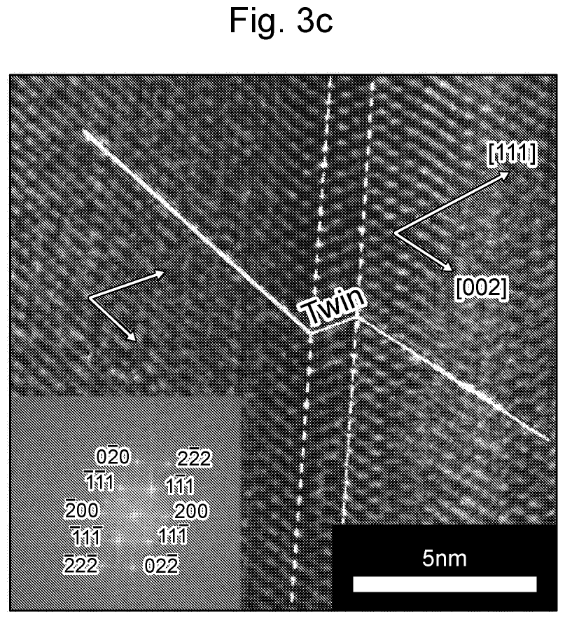

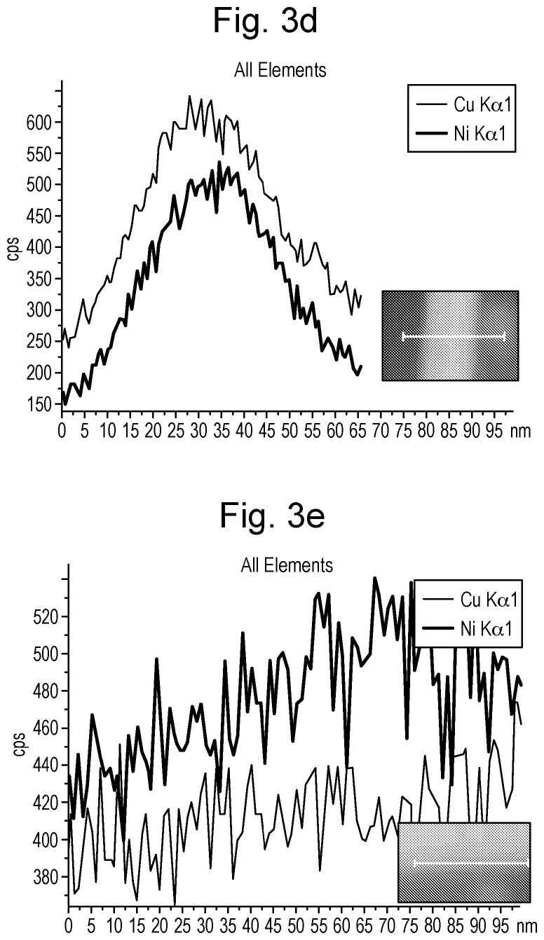

The HRTEM in FIG. 3 shows a single nanowire formed using ZnCl₂ as a precursor. The whole body of the wire is formed by mismatched stacking of atomic planes which are the result of the presence of some defects on the surface of the wire, in particular along the crystal growth direction. A bone-like structure that stretches across the whole length of the whole wire is observed. These structures are believed to be the result of a growth pattern driven by a deficiency in either Cu or Ni in the middle of the nanowire.

The enlarged image of the middle of the wire (FIG. 3(c)) shows the presence of twin defects. The FFT shows a cubic symmetry which corresponds to a copper-nickel nanoalloy of equimolar composition with a lattice spacing of d₁₁₁=0.205 nm. Therefore, the nanowire thus produced corresponds only to one single crystal.

It is believed that a defect on the nanowire induces some form of plastic deformations highlighted by the enlargement in FIG. 3(c). The chemical composition of the nanowire remains constant along the nanowire axis. Both Cu and Ni distributions were investigated using EDX analysis. The EDX maps of Cu and Ni in FIG. 3(b) show that the nanowire (NW) is formed of both elements and that they are evenly distributed. This is confirmed by the EDX elemental analysis graph and the corresponding calculated count for Cu and Ni. Therefore, all the evidence points toward the fact that the nanowire is a true nanoalloy.

Line scans were performed along the axis and perpendicular to the axis of the nanowire. The line scans shown in FIG. 3(d) and FIG. 3(e) confirm that these nanowires are true nanoalloys. An interesting observation is that in the line scans shown, Cu and Ni peaks are not located at the same position. The Cu peak point appears before the nickel peak. This suggests the presence of a Cu defect in the middle of the wire, confirming the origin of the defects shown in the TEM above.

The STEM-EDX shows that the composition in Ni and Cu is uniform in both axial and perpendicular directions. The Cu count is slightly higher than Ni count suggesting that the nanowire is deficient in Ni. In conclusion, it can be confirmed that copper-nickel bimetallic nanowires synthesised using ZnCl₂ as a precursor form true nanoalloys.

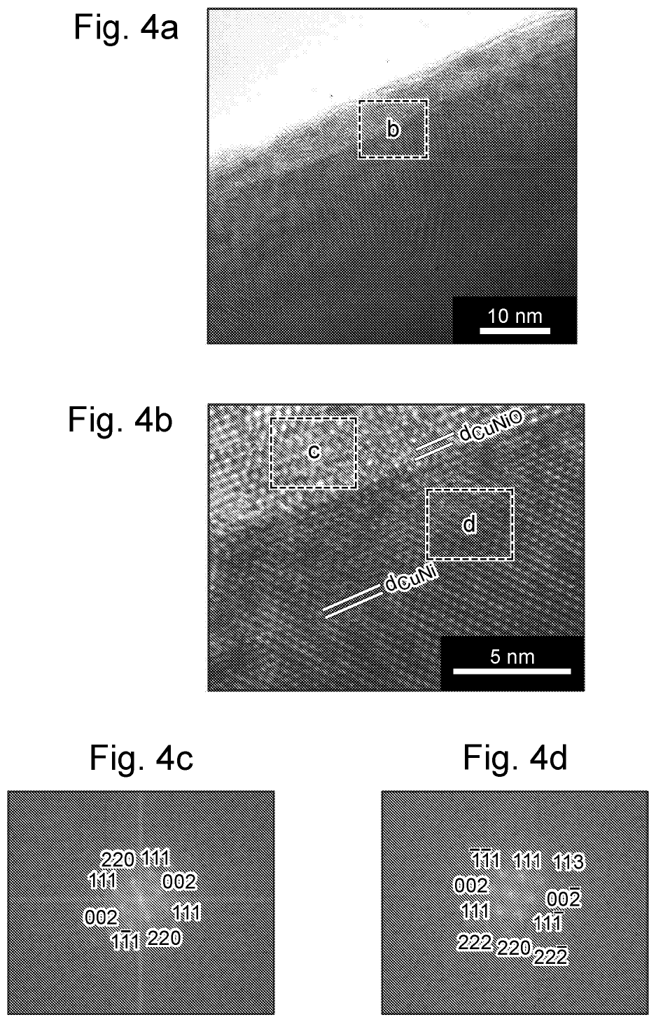

HRTEM analysis helps also to uncover very specific traits of these nanowires. FIG. 4(a) is a detailed image of a copper-nickel (CuNi) nanoalloy edge. Some stacking faults of different directions are visible in the lower part of the image. On the top part of the wire, a very high contrast zone is observed. In this zone, the lattices are very organised and indicate the presence of an oxide on the edge of wire.

A more enlarged image the edge between the two zones of the wire is shown in FIG. 4(b). The FFTs of the nanowire edge displayed in FIG. 4(c) and in FIG. 4(d), and show that both areas have two distinct ordered crystalline structures with a cubic symmetry. It is suggested therefore that the upper part of the wire is made of a copper nickel oxide with a lattice spacing of 0.356 nm. After many days left in air, the oxide layer remains constant (i.e. maintains the same thickness). The oxide formed on a copper nickel alloy has been studied previously and has been concluded to have a protective nature (Pilling et al., Industrial & Engineering Chemistry 17, 372-276 (1925)). It has been observed that in bulk Cu—Ni alloys having between 40-60% Ni content, the oxidation rate is slower than the oxidation rate of pure metals and lower Ni-content alloys. The same trend was observed with the nanowires of the present invention. It was found that leaving the nanoalloys for many days did not impact the total thickness of the top (oxide) layer.

Therefore, it is concluded that the oxide layer is formed instantly and protects the copper nickel alloy instead of diffusing through the layer.

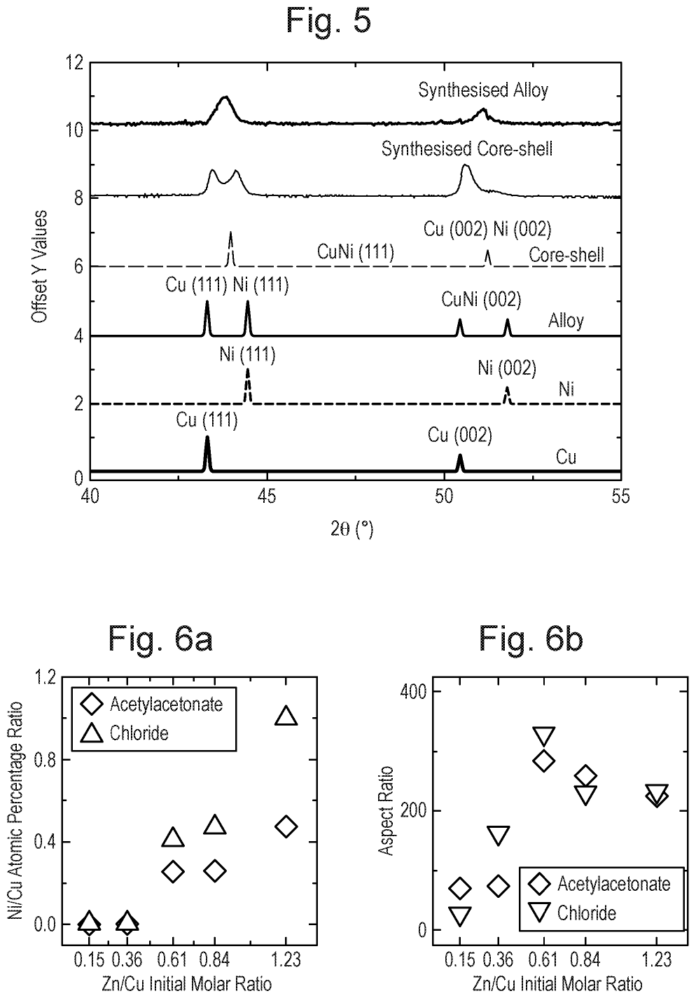

The XRD plot of FIG. 5 compares simulated diffractograms of Cu, Ni, 1:1 Cu:Ni alloy and 0.85:0.15 Cu:Ni core-shell nanowires with experimentally synthesised copper-nickel nanowires. The experimental synthesis used an initial 1.23 Zn/Cu initial ratio with either ZnCl₂ or Zn(acac)₂. Two sets of peaks attributed to Cu, which are the 111 peak at 43.3° and the 200 peak at 50.4°. The peaks attributed to Ni are the 111 at 44.3° and the 200 peak at 51.7°. The peaks appear in both simulated core-shell and copper-nickel nanowires synthesised using Zn(acac)₂ diffractograms. Interestingly, the alloy presents a new set of peaks attributed to CuNi (111) and CuNi (200) at 43.9° and 51.2°.

XRD analysis confirms what was observed with the HRTEM and STEM-EDX analyses: for the same concentration of Zn-based catalyst, the addition of Zn(acac)₂ results in the formation of Cu_{core}/Niₛₕₑₗₗ nanowires while ZnCl₂ forms single crystalline copper-nickel nanoalloys. This study shows the importance of the counterion on the synthesis as it can influence the atomic ordering of the wire. The alloy and core-shell structures present also physical differences: Cu—Ni alloys are single crystalline species exhibiting a very well defined crystal lattice while Cu—Ni core-shell nanowires possess a very rough surface due to the piling up of Ni atoms. Both nanowires possess an oxide layer on the outer layer but its nature differs: the oxide present on the core-shell is a diffusive layer while the alloy has a protective oxide layer.

To understand the role of the Zn species, control experiments were performed replacing ZnCl₂ with NaCl for each Zn/Cu ratio studied (the NaCl concentration was doubled to match Cl⁻ ion concentration). The resulting nanowires were found to be pure copper nanowires.

Furthermore, experiments were performed varying the concentration of the catalyst species in relation to the concentration of copper and zinc in solution. The results are shown in FIG. 6. At low concentrations of both Zn(acac)₂ and of ZnCl₂, pure copper nanowires are formed. This can be seen from the left-hand graph which indicates a Ni/Cu ratio of zero at low Zn concentration. At these low concentrations, the variation of the zinc species serves only to modify the aspect ratio of the copper nanowires thus produced. However, once the Zn concentration in solution is sufficient, nanoalloys also containing nickel are formed.

Thus, it is demonstrated that regardless of the counterspecies, Zn²⁺ acts as a catalyst. By increasing its concentration, the reduction of Ni(acac)₂ precursor is promoted. The counterspecies does however play an important role in defining the final nature of the nanostructure produced. The formation of an alloy occurs when two metal species are reduced simultaneously. The mechanism of formation of alloy is however not fully understood. The standard redox potential of Ni and Cu are far from each other, which makes it impossible for these elements to be reduced at the same time in normal conditions.

It is speculated that the counterspecies of the catalyst (Zn in this case) modifies the standard reduction potential of the first and second metals (here Cu and Ni) by reducing their size. Thus, it is speculated that the exchange of ZnCl₂ to take the place of Zn(acac)₂ as a catalyst modifies the standard reduction potential of Zn²⁺. Moreover, it is speculated that increasing the concentration of the catalyst compensates for the slower reduction of Ni(acac)₂. This dual action allows a co-reduction of both Ni²⁺ and Cu²⁺.

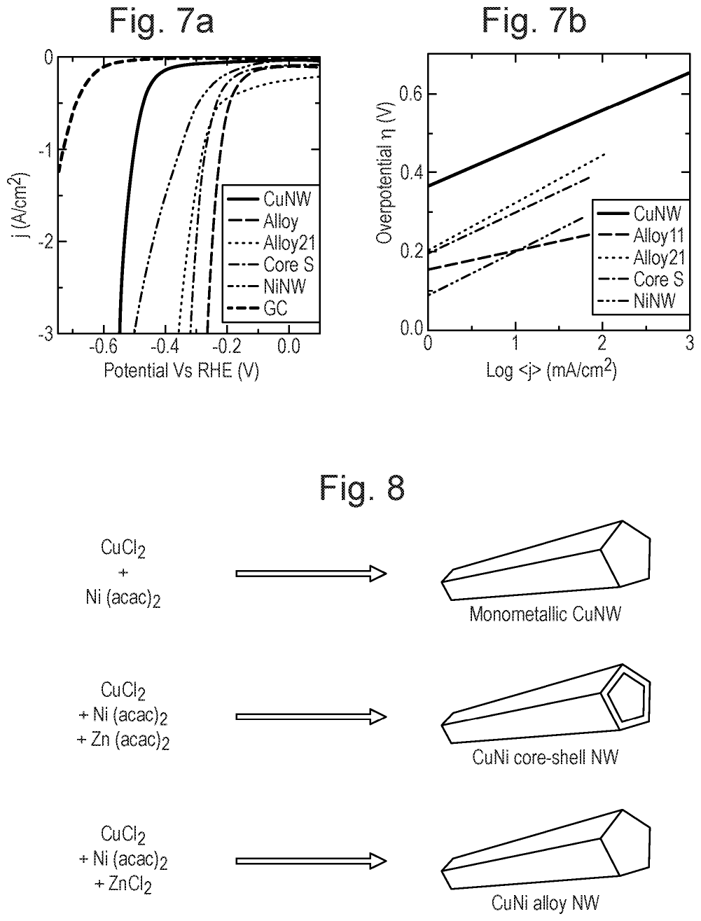

Polarization curves for pure copper nanowires, copper-nickel nanoalloys having a 1:1 and 2:1 atomic ratio, core-shell copper-nickel nanowires and nickel nanowires are displayed in FIG. 7(a). The ratio between Cu and Ni was measured using EDX data. As seen in FIG. 7(a), the overpotential varies greatly from 0.41V for copper nanowires to a much lower value of 0.12V for the 1:1 nanoalloy. It is well-established that materials with lower overpotential are favourable as hydrogen storage means and hydrogen evolution means as they require less energy is required to generate the same amount of hydrogen. Thus, the 1:1 nanowire alloy is a considerably more favourable candidate for hydrogen storage and hydrogen evolution than copper.

Surprisingly, the current density curve as a function of the potential is very similar for both core-shell nanowires and nickel nanowires. This is in accordance with the dominance of physical properties by the shell portion of the nanowire.

The Figure also shows a composition-activity dependence. The overpotential in relation to the hydrogen evolution reaction increases by 0.23V when passing from a 1:1 to a 2:1 alloy. This suggesting that the HER performance of such a nanoalloy with nickel content until a 1:1 ratio is reached. This is in accordance with the volcano curve of the exchange current density as a function of the calculated free Gibbs energy.

It is well established that Ni and Cu have opposite properties in terms of catalytic activity. Ni is known to have a low electrocatalytic activity due to a weak adsorption of hydrogen on the Ni surface. By contrast, the electrocatalytic activity of Cu is too high: Cu has a too great a bonding strength and therefore fails to release the adsorbed hydrogen. It appears therefore that combining Cu and Ni allows each metal to compensate for the disadvantages of their monometallic counterparts. Tafel plots extracted from the polarization curves and current densities for copper, 1:1 Cu:Ni alloys, 2:1 Cu:Ni alloys, CuNi core-shell structures and nickel nanowires yield Tafel slopes of 60, 21, 43, 44 and 39 mV/decade respectively. The Tafel slopes values indicate the mechanism by which the H₂ is adsorbed and desorbed by the metal, which is the Tafel step for CuNi alloyed NW. This means that the addition of Ni to the NW is efficient in lowering down the binding strength energy between Cu and the hydrogen bond.

The Tafel slope of the 1:1 copper-nickel nanoalloy is comparable to that of Pt, which is currently the best material in the market for hydrogen storage and evolution.

It also important to note that the activity of an electrocatalyst is influenced by factors such as the roughness of the material, its crystallinity or conductivity. It is therefore likely that other parameters such as the crystallinity and roughness of the material contribute to the enhanced activity of CuNi alloy nanowires observed herein.

The exchange current density of the various nanowires discussed herein was also measured. This indicates the rate of reaction at equilibrium potential. The alloys and the core-shell structures disclosed herein were found to present higher values, indicating better catalytic performance.

1. A process for producing a nanostructure wherein the nanostructure comprises:
a first metal having a first reduction potential; and
a second metal having a second reduction potential, the second reduction potential being more negative than the first reduction potential,
wherein the process comprises treating a fatty species comprising a polar moiety capable of coordinating to a metal ion with:
a salt of the first metal;
a salt of the second metal; and
a catalyst,
the catalyst being a salt of a reducing metal, the reducing metal having a reduction potential that is more negative than both the first and the second reduction potentials.

2. A process according to claim 1 wherein the polar moiety of the fatty species is selected from a thiol group, a phosphate group, a carboxylic acid group and an amine group.

3. A process according to claim 1 or 2 wherein the fatty species comprises a saturated or unsaturated carbon chain comprising at least 8 carbon atoms.

4. A process according to any preceding claim wherein the fatty species is a fatty amine.

5. A process according to any preceding claim wherein the fatty species is a primary amine.

6. A process according to any preceding claim wherein the fatty amine is oleylamine.

7. A process according to any preceding claim wherein the reduction potential of the reducing metal is negative.

8. A process according to any preceding claim wherein the reduction potential of the reducing metal is less negative than −2.9 V.

9. A process according to any preceding claim wherein the reduction potential of the reducing metal is more negative than −0.3 V.

10. A process according to any preceding claim wherein the reduction potential of the reducing metal is from −2.9 V to −0.3 V.

11. A process according to any preceding claim wherein the reducing metal is a transition metal.

12. A process according to any preceding claim wherein the reducing metal is selected from chromium, cobalt, iron, zinc, manganese, cadmium or vanadium, preferably zinc.

13. A process according to any preceding claim wherein the nanostructure comprises:
a first metal having a first reduction potential;
a second metal having a second reduction potential, the second reduction potential being more negative than the first reduction potential, and
a third metal having a third reduction potential, the third reduction potential being more negative than the second reduction potential;
wherein the process comprises providing a mixture of:
a salt of the first metal;
a salt of the second metal;
a salt of the third metal;
a catalyst; and
a fatty species comprising a polar moiety capable of coordinating to a metal ion,
the catalyst being a salt of a reducing metal, the reducing metal having a reduction potential that is more negative than each of the first, second and third reduction potentials.

14. A process according to any preceding claim wherein:
the salt of the first metal comprises a first ligand;
the salt of the second metal comprises a second ligand; and
where present, the salt of the third metal comprises a third ligand;
wherein the said first, second and third ligands are each independently negatively charged or uncharged.

15. A process according to claim 14 wherein the said ligands are each independently selected from hydroxide, oxide, halide, nitrate, nitrite, sulphide, sulphate, sulphite, thiosulphate, thiocyanate, isothiocyanate, azide, phosphate, phosphite, carbonate, hydrogencarbonate, oxalate, cyanate, cyanide, hypochlorite, chlorite, chlorate, perchlorate, chromate, dichromate, permanganate, C₁-C₁₆ alcohol, deprotonated C₁-C₁₆ alcohol, C₁-C₂₄ diol, deprotonated C₁-C₂₄ diol, C₁-C₁₆ thiol, deprotonated C₁-C₁₆ thiol, C₁-C₂₄ dithiol, deprotonated C₁-C₂₄ dithiol, C₁-C₁₆ carboxylic acid, C₁-C₁₆ carboxylate, C₂-C₂₄ dicarboxylic acid, C₂-C₂₄ dicarboxylate, C₂-C₁₆ ketone, C₃-C₂₄ diketone, deprotonated C₃-C₂₄ diketone, acetylacetonate, CO, C₂-C₁₆ nitrile, C₁-C₁₆ amine, C₁-C₂₄ diamine or ammonia.

16. A process according to claim 14 or claim 15 wherein at least one of the first ligand and the second ligand is acetylacetonate.

17. A process according to any one of claims 14 to 16 wherein at least one of the first ligand and the second ligand is halide, preferably chloride.

18. A process according to any preceding claim wherein the first reduction potential and the second reduction potential are more negative than 1 V and preferably more positive than −0.3 V.

19. A process according to any preceding claim wherein the third reduction potential is less than 1 V and preferably more positive than −0.3 V.

20. A process according to any preceding claim wherein the first and/or the second metal is a transition metal.

21. A process according to any preceding claim wherein the first and/or second metal is a non-noble transition metal.

22. A process according to any preceding claim wherein the first metal is copper.

23. A process according to any preceding claim wherein the second metal is selected from iron, tin, cobalt, manganese or nickel, preferably nickel.

24. A process according to any preceding claim wherein the third metal, when present, is as defined in any one of claims 20 to 23.

25. A process according to any preceding claim wherein the process comprises treating the fatty species in the presence of a non-polar solvent.

26. A process according to claim 25 wherein the non-polar solvent comprises a saturated or unsaturated hydrocarbon.

27. A process according to claim 26 wherein the non-polar solvent is a C₈ to C₂₂ hydrocarbon solvent, preferably 1-octadecene.

28. A process according to any preceding claim wherein the process comprises:
(i) heating the reaction mixture at a temperature of 100° C. or less to dissolve the salt of the first metal, the salt of the second metal, the salt of the third metal (where present) and the catalyst.

29. A process according to any preceding claim wherein the process comprises:
(ii) heating the reaction mixture at a temperature of 200° C. or less, preferably for a period of from 30 minutes to 10 hours.

30. A process according to claim 29 wherein the process comprises, after step (ii):
(iii) adding a polar solvent and a further non polar solvent to the reaction mixture.

31. A process according to any preceding claim wherein treating the fatty species comprising a polar moiety capable of coordinating to a metal ion with the salt of the first metal, the salt of the second metal and the catalyst is performed under an inert atmosphere, preferably a noble gas atmosphere.

32. A process according to any preceding claim which further comprises recovering the nanostructure.

33. A process according to any preceding claim wherein the process comprises reducing the salt of the first metal and the salt of the second metal simultaneously.

34. A process according to any preceding claim for producing a nanoalloy, wherein the catalyst which is a salt of the reducing metal comprises a metal cation and a counterspecies, the counterspecies being an anion consisting of one, two or three atoms.

35. A process according to claim 34 wherein the anion consists of one atom.

36. A process according to claim 35 wherein the anion is a halide ion, preferably a chloride ion.

37. A process according to any one of claims 1 to 32 wherein the nanostructure comprises a core of the first metal and a shell of the second metal, wherein the catalyst which is a salt of the reducing metal comprises the reducing metal and a counterspecies, which counterspecies is not a halide ion.

38. A process according to claim 37 wherein the counterspecies comprises four or more atoms.

39. A process according to claim 37 or claim 38 wherein the counterspecies is selected from C₃-C₆ alcohol, deprotonated C₃-C₆ alcohol, C₁-C₈ carboxylic acid, C₁-C₈ carboxylate, C₂-C₆ ketone, deprotonated C₂-C₆ ketone, C₃-C₁₂ diketone, deprotonated C₃-C₁₂ diketone, CO, or C₂-C₆ nitrile, preferably acetylacetonate.

40. A process according to any one of claims 37 to 39 wherein the counterspecies comprises six or more atoms.

41. A nanostructure obtainable by a process according to any preceding claim.

42. A nanoalloy obtainable by a process according to any one of claims 33 to 36.

43. A core-shell nanostructure obtainable by a process according to any one of claims 37 to 40.

44. A nanostructure according to any of claims 41 to 43 wherein the nanostructure is in the form of a nanowire or nanodisc, preferably a nanowire.

45. A nanoalloy comprising:
a first metal having a first reduction potential; and
a second metal having a second reduction potential, the second reduction potential being more negative than the first reduction potential.

46. A nanoalloy according to claim 45 further comprising a third metal having a third reduction potential, the third reduction potential being more negative than the second reduction potential.

47. A nanoalloy according to claim 45 or claim 46 wherein the nanoalloy comprises at least one non-noble metal.

48. A nanoalloy according any one of claims 45 to 47 wherein the nanoalloy consists of a single phase which is a solid solution of the first, second and optionally the third metal.

49. A nanoalloy according to any one of claims 45 to 48 wherein the nanoalloy comprises a substantially uniform spatial distribution of the first metal, the second metal, and where present the third metal throughout the nanoalloy.

50. A nanoalloy according to any one of claims 45 to 49 wherein the nanoalloy comprises a region of uniform spatial distribution of the first metal, the second metal, and where present the third metal, said region being at least 100 nm³ in volume.

51. A nanoalloy according to any one of claims 45 to 50 wherein M1 is the concentration of the first metal and M2 is the concentration of the second metal, and the ratio M1:M2 varies by less than 5% along at least one dimension of the nanoalloy.

52. A nanoalloy according to claim 51 wherein the nanoalloy is in the form of a nanowire, wherein the ratio M1:M2 varies by less than 5% across the diameter of the nanowire.

53. A nanoalloy according any one of claims 45 to 52 wherein the nanoalloy comprises a third metal and M3 is the concentration of the third metal, and the ratios M1:M3 and M2:M3 vary by less than 5% along at least one dimension of the nanoalloy.

54. A nanoalloy according to claim 53 wherein the nanoalloy is in the form of a nanowire, wherein the ratios M1:M3 and M2:M3 vary by less than 5% across the diameter of the nanowire.

55. A nanoalloy according to any one of claims 45 to 54 wherein the nanoalloy comprises a crystalline face.

56. A nanoalloy according to any one of claims 45 to 55 wherein the nanoalloy is monocrystalline.

57. A nanoalloy according to any one of claims 45 to 56 having a largest dimension which is 10 μm or larger, preferably 200 μm or larger and preferably less than 1000 μm.

58. A nanoalloy according to any one of claims 45 to 57 having a smallest dimension which is 500 nm or smaller; and is preferably 200 nm or smaller and greater than 1 nm.

59. A nanoalloy according to any one of claims 45 to 58 wherein the ratio of the largest dimension to the smallest dimension of the nanoalloy is 10 or more.

60. A nanoalloy according to any one of claims 45 to 59 wherein the nanoalloy is in the form of a nanowire.

61. A nanoalloy according to any one of claims 45 to 59 wherein the nanoalloy is in the form of a nanodisc.

62. A nanoalloy according to any one of claims 45 to 61 wherein the first metal is as defined in any one of claims 18, 20, 21 and/or 22.

63. A nanoalloy according to any one of claims 45 to 62 wherein the second metal is as defined in any one of claims 18, 20, 21 and/or 23.

64. A nanoalloy according to any one of claims 45 to 63 wherein the third metal is present and is as defined in claim 19 and/or claim 24.

65. A nanoalloy according to any one of claims 45 to 64 wherein the ratio of the number of atoms of the first metal to the number of atoms of the second metal in the nanoalloy is from 5:1 to 1:5, preferably from 2:1 to 1:2, most preferably 1:1.

66. A nanoalloy according to any one of claims 45 to 65 wherein the third metal is present and:
the ratio of the number of atoms of the first metal to the number of atoms of the third metal in the nanoalloy is from 5:1 to 1:5, preferably from 2:1 to 1:2, most preferably 1:1; and
the ratio of the number of atoms of the second metal to the number of atoms of the third metal in the nanoalloy is from 5:1 to 1:5, preferably from 2:1 to 1:2, most preferably 1:1.

67. A nanoalloy according to any one of claims 40 to 60 wherein the nanoalloy comprises at least 90% metal by weight, preferably at least 95% metal by weight, more preferably at least 99% metal by weight, for instance about 100% metal by weight.

68. A nanoalloy according to any one of claims 45 to 67 wherein the nanoalloy comprises less than 10% oxygen by weight, preferably less than 5% oxygen by weight, more preferably less than 1% oxygen by weight, for instance about 0% oxygen by weight.

69. A nanoalloy according to any one of claims 45 to 68 wherein the overpotential of the nanoalloy with respect to the hydrogen evolution reaction is less than 0.6 V, preferably less than 0.5 V.

70. An oxide-coated nanoalloy comprising:
a nanoalloy as defined in any one of claims 45 to 69; and
a coating on the surface of the nanoalloy comprising a metal oxide.

71. An oxide-coated nanoalloy according to claim 70 wherein the metal oxide comprises an oxide of the first metal and/or an oxide of the second metal.

72. An oxide-coated nanoalloy according to claim 70 or 71 wherein the nanoalloy comprises 5% oxygen by weight or less.

73. An oxide-coated nanoalloy according to any one of claims 70 to 72 wherein the metal oxide further comprises an oxide of the third metal.

74. A process according to any of claims 33 to 36 wherein the process is a process for producing a nanoalloy according to any one of claims 45 to 69 or an oxide-coated nanoalloy according to any one of claims 70 to 73.

75. A hydrogen storage module comprising a nanoalloy as defined in any one of claims 45 to 69 and/or an oxide-coated nanoalloy as defined in any one of claims 70 to 73.

76. A transparent conductor comprising a nanoalloy as defined in any one of claims 45 to 69 and/or an oxide-coated nanoalloy as defined in any one of claims 70 to 73.

77. Use of a nanoalloy as defined in any one of claims 45 to 69 and/or an oxide-coated nanoalloy as defined in any one of claims 70 to 73 in a method of hydrogen storage.

78. Use of a nanoalloy as defined in any one of claims 45 to 69 and/or an oxide-coated nanoalloy as defined in any one of claims 70 to 73 as a hydrogen storage material in a method of hydrogen storage.

79. Use of a nanoalloy as defined in any one of claims 45 to 69 and/or an oxide-coated nanoalloy as defined in any one of claims 70 to 73 in the manufacture of a transparent conductor.

80. Use of a nanoalloy as defined in any one of claims 45 to 69 and/or an oxide-coated nanoalloy as defined in any one of claims 70 to 73 as a catalyst.
